(19) United States
(12) Patent Application Publication
(10) Pub. No.: US 2026/0310708 A1
(43) Pub. Date: Oct. 8, 2026

(54) Human-Machine Knowledge Experience (KX) AI Support and Evaluation System with Contribution Tracking

(71) Applicants: William Cope, Champaign, IL (US); Duane Searsmith, Mahomet, IL (US); Phillip Kalantzis-Cope, Champaign, IL (US)

(72) Inventors: William Cope, Champaign, IL (US); Duane Searsmith, Mahomet, IL (US); Phillip Kalantzis-Cope, Champaign, IL (US)

(21) Appl. No.: 19/171,245

(22) Filed: Apr. 5, 2025

(51) Int. Cl. G06F 16/34; G06F 9/451; G06F 16/383; G06Q 10/101

(52) U.S. Cl. CPC G06F 16/34; G06F 9/453; G06F 16/383; G06Q 10/101

(57) ABSTRACT

An AI-assisted writing and evaluation system provides full generative AI support to a human writer while tracking the source of contributions to ensure transparency and accountability. The system defines a knowledge frame with a task orientation, an evaluation rubric, and an optional knowledge base, configured by a knowledge administrator. A knowledge creator (human user) works within a content editor, calling on an AI helper for suggestions and improvements. Contextual AI instrumentation logs user keystrokes, edits, and AI interactions in real time, attributing each segment of content as human- or AI-generated. Using this detailed activity log, the system evaluates the completed work against the mix of human vs. AI contribution. It produces a quantitative measure of the human's original effort (versus AI assistance) and qualitative feedback explaining the evaluation. This approach allows users to leverage AI assistance verifiably distinguishing the user's own cognitive work from AI contributions.

### CROSS-REFERENCE TO RELATED APPLICATIONS

This application claims the benefit of U.S. Provisional Patent Application No. 63/730,019, filed Dec. 10, 2024, which is incorporated herein by reference in its entirety.

### PRIOR ART

This application continues U.S. Pat. No. 7,886,225B2 , “Method and apparatus for the creation, location and formatting of digital content” previously registered by Common Ground Publishing LLC.

Various systems have been developed to assist in writing, editing, and evaluating documents, as well as to ensure the originality and integrity of written work. For example, in collaborative editing environments, there are tools for tracking document changes by human co-authors. U.S. Pat. No. 10,552,799 B2 to Microsoft is one such system that manages content in shared documents, aligning portions of an older version of a document with a new version to identify which author wrote each segment, then stores authorship metadata for every substring, though it does not address textual authorship attribution from AI sources. The KX system provides a more comprehensive solution specifically designed for the modern challenge of human-AI collaboration, offering transparency, accountability, and evaluation mechanisms that are absent in systems focused solely on human-human collaboration tracking.

Meanwhile, modern AI-driven writing assistants like that in U.S. Pat. No. 11,886,826 B1 (OpenAI) can generate and insert text into a draft to help writers compose documents more efficiently. However, these AI assistants operate as blind helpers—they insert text but do not record who wrote what. There is no built-in accountability or transparency for distinguishing AI-generated passages from human-written passages in the final document. The KX system integrates the power of generative AI (like that described by OpenAI) with crucial mechanisms for transparency, accountability, evaluation, and responsible use, addressing the significant gaps left by standalone generative models operating without provenance tracking.

In the educational domain, prior art has focused on either providing feedback or assessing completed writing. For instance, U.S. Pat. No. 11,176,321 B2 (IBM) describes an automated feedback system for students, where an AI monitors a student's sentence as it is being written and flags unlikely word choices as errors. This improves grammar and style in real-time but, notably, all the writing is assumed to be the student's own; the system does not involve an AI co-writer or any tracking of authorship. Similarly, U.S. Pat. No. 12,046,155 B1 (ETS) uses machine learning to evaluate the quality of a student's finished essay, identifying the presence of logical critiques in each sentence for grading purposes. While such a system can judge the content of writing, it looks only at the end product (the essay) and has no mechanism to determine how the essay was written or whether portions were generated by an AI assistant. In summary, existing educational tools either help a student write better or evaluate the writing after the fact; none of them document the contributions of an AI during the writing process.

In professional and specialized writing contexts, other inventions aim to improve documentation accuracy. U.S. Pat. No. 11,100,289 B2 (Cerner) is directed to clinical documentation, where an AI cross-checks a doctor's notes against prior medical records to ensure consistency and completeness. This kind of system treats the human author as the sole content creator and the AI as a reviewer or proofreader. The AI may suggest adding missing information, but it does not author any part of the note, nor does it attribute sections of text to itself. Thus, while it enhances document quality by validating content, it does not address issues of mixed human/AI authorship or accountability for who drafted the text.

Separately, a significant body of prior art exists around detecting plagiarism or improperly sourced content in written work. Traditional plagiarism detection, exemplified by patents like U.S. Pat. No. 6,976,170 B1 (Kelly) and the Turnitin system (e.g., U.S. Pat. No. 8,296,661 B2), relies on comparing a submitted work to a database of existing texts. These systems flag copied or closely similar passages effectively, but they have clear limitations: they cannot detect material that has been paraphrased to avoid direct matches, nor can they identify content that is wholly original yet written by an AI on behalf of a user. Improvements such as the published application US 2013/0073575 A1 (Turnitin) attempt to reduce false alarms from common phrases by ignoring ubiquitous “small matches,” and other academic tools like U.S. Pat. No. 8,577,898 B2 (KACST) have tried to infer originality by analyzing writing style deviations. However, these approaches still operate on the final text only—they either look for overlaps with known sources or unusual writing style fingerprints after the writing is completed.

US 2018/0150752 A1 describes technologies for identifying artificial intelligence content by analyzing received content to determine if it was generated by an AI source, with the result displayed to indicate this determination. This approach is reactive, focusing on post-creation analysis to classify existing documents as AI-generated or not, and may struggle with original or paraphrased AI content due to its reliance on detection rather than tracking. In contrast, the present invention, the Human-Machine Knowledge Experience (KX) AI Support and Evaluation System with Contribution Tracking, integrates real-time tracking during the writing process, logging and attributing contributions at a granular level, such as individual sentences, with features like visual indication of origins, provenance verification, and effort quantification using Ergons. Unlike US 2018/0150752A1's binary identification, the invention provides proactive, dynamic tracking and regulation of AI assistance, ensuring transparency and accountability throughout the creation process, particularly in collaborative and regulated environments, and addressing gaps in detecting novel AI-generated content.

Google's patent U.S. Pat. No. 10,467,180 B2 relates to systems like Smart Compose, where a neural network predicts and suggests text (words or phrases) based on the user's current writing context and potentially their historical data or common patterns, with a focus on efficient text input and suggestion accuracy. The KX system offers a much broader range of AI assistance (beyond mere autocomplete) and integrates it into a comprehensive framework that tracks contributions, evaluates based on provenance, quantifies effort, and improves AI interaction via semantics, providing a complete human-AI knowledge creation environment rather than just an input efficiency tool.

Some code generators embody functions that appear to be analogous to those in the KX system, such as U.S. Pat. No. 11,397,843 B2 which generates software code using a machine learning model based on prompts and contextual information. In contrast the KX system addresses the specific challenges of human-AI collaboration in natural language knowledge work, providing tailored tracking, evaluation, semantic grounding, and effort quantification mechanisms not found in AI code generation tools.

More recently, recognizing the challenge of AI-generated content, U.S. Pat. No. 11,853,708 B1 (Holovisions) has introduced a human-in-the-loop verification method. After a student submits an essay, this system will test the student's understanding of obscure words in the essay to catch cases where an AI may have supplied those words. This approach, while innovative, again engages after the document is written and requires additional interaction (quizzing the student) to ascertain authorship—a process that can be cumbersome and is not integrated into the writing tool itself.

In the area semantic mapping, U.S. Pat. No. 9,881,107 B2 (IBM) outlines a system for mapping unstructured text into a knowledge graph, identifying entities, relationships, and concepts, and then mapping these into a structured knowledge graph format for the purposes of knowledge discovery, semantic search, and data integration. The KX system uniquely combines real-time semantic enrichment (&tag system) with generative AI assistance and contribution tracking, using semantics not just for post-hoc analysis but as an active tool to improve the human-AI interaction and AI reliability during content creation, within a comprehensive tracking and evaluation framework.

Problems to be Solved: In summary, the prior art reveals a gap in the area of real-time contribution tracking when AI is used as a writing partner. Existing collaborative editing tools credit human co-authors but ignore AI contributions; AI writing assistants generate text but leave no audit trail of their involvement; and plagiarism and originality checkers attempt to detect misconduct only after the fact, often with imperfect heuristics. No known system provides a seamless way to transparently integrate AI assistance into the writing process while simultaneously logging and evaluating the extent of that assistance.

Furthermore, while various user activity monitoring tools exist for analytics or productivity tracking, these systems typically do not focus on the specific problem of authorship attribution in mixed human-AI scenarios. They may log keystrokes, time spent, or application usage, but lack the mechanisms to parse these actions into meaningful contributions attributed to distinct sources (human vs. specific AI tool vs. external copy-paste) within the document content itself, nor do they dynamically update such attributions based on subsequent editing activity

Additionally, existing systems incorporating semantic technologies often focus on post-creation analysis, knowledge management, or backend data linking (e.g., within Content Management Systems). They generally do not integrate real-time semantic tagging directly into the writing interface as a means for the user and system to collaboratively disambiguate content, ground AI generation to reduce errors or hallucinations, and track the conceptual provenance alongside textual contributions.”

How the Present Invention Improves Upon the Prior Art: The present invention addresses the above gap by combining a generative AI writing assistant with a real-time authorship tracking mechanism. Unlike any of the cited references, it actively records which portions of text were suggested or authored by the AI and which by the human user, during the act of writing. For example, if a student uses the AI to generate a few sentences of an essay, the system will mark those sentences as AI-generated in an associated log or metadata. This approach yields an immediate benefit: at any point, one can review a “contribution report” to see the ratio, sources, and kinds of AI input versus human content.

Such functionality goes beyond the scope of prior art plagiarism detectors (which would only examine the final text for similarities) by catching potential issues even when the AI-generated content is entirely novel. It also provides a more proactive and educational solution than post-hoc quizzing: the student and instructor are aware, upfront, of how much help the student is receiving from AI, the sources of this help, and the kinds of help being offered. In contrast to IBM's feedback tool or Cerner's clinical checker—which assist the user but treat all input as human—the present system ensures that AI contributions are not hidden. This transparency discourages over-reliance on AI in scenarios where the human is expected to do the majority of the work (academic assignments, scholarly writing, legal drafting etc.), thereby upholding the integrity of the writing process.

Furthermore, by having this detailed contribution tracking, the invention can enforce or recommend limits on AI assistance. No prior system provides a way to automatically say “the AI wrote 40% of this document” and compare that against a desired threshold. Nor is it able define the kind of assistance (e.g. planning versus proofreading), and the sources of included text. The disclosed invention can do so, alerting a user or supervisor if, say, an essay has too much AI-written content, or conversely, if an AI tool could be utilized more in a scenario where efficiency is paramount (e.g., drafting boilerplate sections). In essence, the invention creates a balanced collaboration between human and machine writers that was not achievable with earlier technologies.

Moreover, the prior art lacks a system that quantifies the differential effort involved in mixed human-AI knowledge creation using a dedicated metric (such as the ‘Ergon’ described herein) that accounts for not only direct writing but also collaborative acts like peer review or AI training feedback. Existing collaboration or gamification platforms do not address the unique challenges of valuing and incentivizing contributions in a human-AI synergistic environment.”

The present invention is also distinct from adaptive learning systems or AI tutors that might adjust difficulty or feedback style. While those systems adapt based on user performance, they typically do not do so based on a continuously updated, granular log of real-time human vs. AI writing contributions combined with explicit Zone of Proximal Knowledge (ZPK) modeling derived from the writing process itself, nor do they integrate this adaptation within a comprehensive contribution tracking and evaluation framework.”

Therefore, the prior art fails to disclose or suggest the synergistic combination presented herein: a system providing generative AI writing support tightly integrated with a real-time, granular contribution tracking module that dynamically attributes text origin (human, AI, external), enriches content semantically to ground AI interactions, quantifies diverse contribution efforts through a novel credit mechanism, and utilizes this detailed provenance data within an embedded evaluation and moderation framework, all operating within a secure and privacy-preserving architecture.

In sum, the present invention differentiates itself from the prior art by integrating generative AI with real-time provenance tracking. None of the known references combine these features. By addressing both the creative assistance and the accountability aspects, the invention ensures that the resulting document's origin is transparent. This improves upon prior systems by preventing plagiarism and misattribution before they occur, maintaining trust in the authenticity of the document, and ultimately enabling a responsible use of AI in writing that the prior art could only partially support.

### FIELD OF INVENTION

The present invention relates to computer-assisted writing and knowledge creation systems, and more particularly to an AI-powered writing assistant that collaborates with a human writer. It addresses fields such as publishing, education, medical informatics, and legal drafting any domain in which artificial intelligence might support the representation and documentation of cognitive work. The invention is also a contribution to the field of Human-Centered AI, ensuring transparent human-AI relations in knowledge activities that involve a synergistic collaboration between human creators and their AI supports. It further provides reliable evaluation of the quality and provenance of human knowledge work relative to AI assistance, with privacy and security safeguards (e.g. an anonymizing firewall between the local system and external foundation models).

### BACKGROUND OF THE INVENTION

Prior Art and Need for Invention: Existing word processors and AI writing assistants offer features like grammar checking or text autocompletion, but none provide real-time tracking of AI-generated content contributions. In current tools, once AI-suggested text is inserted, there is no mechanism to attribute or quantify the AI's input versus the user's input. This lack of attribution creates risks of plagiarism and makes it difficult to audit a document's authorship. Some editing platforms track multiple human collaborators, but no existing system distinguishes an AI agent's input from a human's, which presents unique challenges in accountability. This invention fills that gap by introducing a contribution tracking module integrated with the AI suggestion engine. Unlike black-box AI assistants that produce text with no record of origin, the proposed system continuously logs contributions from each source (human or AI), producing a persistent authorship map of the document. A writer using this system can later review their document and instantly see which parts were AI-suggested and which were written or heavily edited by the human—a level of transparency not possible with prior tools. It thereby enables collaborative content creation where AI contributions are clearly identified, improving accountability and allowing fine-grained editing control.

As well as this general application, related, industry-specific technologies include Manuscript Management Systems (MMS) in the field of publishing, Learning Management Systems (LMS) in the field of education, and Electronic Health Records (EHR) in the field of medicine, and similar knowledge creation, recording and documentation systems across a wide range of human knowledge endeavors.

Until recently, the umbrella concept for human-computer interaction technologies has been UX, or user experience systems. However, with the advent of artificial intelligence the concept of “user” fails to capture or track the synergistic relation of human and machine agencies. When interacting with AI, the human is no longer merely a user. “User” may have been an apt descriptor when the computer was used as a blank space, recording their knowledge activities in the lightly structured systems and methods such as forms, text editors, and file upload applications. In this invention, by contrast, a participant in a Knowledge Experience (KX) system is a human-in-the-AI-loop, a cyber-social co-creator of knowledge. The AI has become a collaborator in the synergistic co-construction of knowledge and the learning that accompanies this knowledge.

From an accountability point of view, with the advent of AI it becomes imperative to track and evaluate the human-machine relations in a KX system. Within the overall framework of KX, there can be specialized variants including RX (researcher experience), LX (learner experience), and HX (patient and medical practitioner health experience), among numerous other such specialized possibilities across many domains of social and professional practice.

Integrated AI Writing Workspace: In one aspect, the invention provides a writing workspace that tightly integrates a generative AI engine (for real-time writing suggestions and feedback) with a contextual tracking module (for monitoring and attributing each contribution). As the human writer types, the AI engine can suggest text or edits, and the system flags suggested text with an “AI” origin marker. Whenever the user accepts, rejects, or edits an AI suggestion, the contribution log is updated accordingly. This combined system enhances writing efficiency by leveraging AI assistance while maintaining an explicit record of the origin of each portion of text. The result is a dynamic collaboration: the human is not merely a user of a tool but a “human-in-the-AI-loop” co-creator, with the AI acting as a proactive collaborator. This paradigm shift reframes “user experience (UX)” as “Knowledge Experience (KX)”, recognizing that when AI is involved, the human is part of a cybernetic co-creation process rather than a solitary author.

When material is copied and pasted from an external source, browser and clipboard activity tracks that source, and the source of the copying is attributed in the system. This may be flagged as legitimate copying, when for instance the introduced material is marked as a direct quote by opening and closing inverted commas or indentation, and the source is correctly attributed. Other times, when for instance, the user has an incognito browser window open such as a third party AI, the cut and pasted material is by default flagged as plagiarized, requiring further verification by the author.

Evolving the Notion of User Experience (UX) to Knowledge Experience (KX): Traditional human-computer interaction models (UX) treat the computer as a passive instrument or blank canvas. In contrast, this invention positions the AI as an active collaborator in knowledge creation. Within a KX system, the human creator and the AI form a synergistic partnership, each contributing to the development of the content. This requires tracking both participants'contributions for transparency and accountability. The invention is adaptable to specialized variants of KX, for example: RX (Researcher Experience) for academic research writing, LX (Learner Experience) for educational assignments, and HX (Health Experience) for medical documentation and many others, depending on the targeted domain including for instance, legal drafting. In each case, the core system ensures that the human's intellectual effort is distinguishable and creditable even when AI assistance is used extensively.

Problems Solved by the Technology: Since the advent of powerful Generative AI tools, it has become increasingly difficult to trace the provenance of knowledge work presented by a human. A document written with AI assistance may contain entirely original AI-generated text that mimics human writing, evading traditional plagiarism checks. Existing “AI detectors” are unreliable, often flagging false positives (wrongly accusing genuine human work as AI-generated) and false negatives (failing to detect AI-assisted content). Some users even employ “AI output humanizers” to intentionally circumvent detectors, rendering such tools ineffective. As a result, educators, publishers, and employers face uncertainty: to what extent is a given piece of work the product of the human's own cognitive effort versus AI assistance? This invention directly addresses that uncertainty by instrumenting the writing process itself to log and analyze the human-AI interaction.

Beyond plagiarism, a larger issue is cognitive offloading: if AI does too much of the work, the human may not be learning or contributing to their place of employment as expected. Different domains frame this concern in various ways: for publishers and research organizations, it is a question of how much a writer or researcher offloaded intellectual work to the AI versus how much the AI constructively extended their thinking. For teachers evaluating students, it is a question of whether the AI performed thinking tasks the student should have done, versus pushing the student to think more deeply (thus actually learning with AI). In medicine, it is a question of ensuring that an AI never becomes a substitute for a clinician's own analysis and judgment, even as it provides expansive medical knowledge to inform those judgments. Similar questions arise for many other domains of cognitive work. The invention provides a workspace that captures detailed evidence of knowledge construction as a proxy for cognitive activity, allowing analysis of how AI was used: as a crutch or as a catalyst for deeper human effort.

By instrumenting the Knowledge Experience (KX) process, this technology solves the provenance problem for AI-assisted work. Knowledge creators (writers, students, professionals) can benefit fully from AI support without fear of unearned accusations of cheating or plagiarism, because the system provides an audit trail of AI vs. human contributions and the nature of these contributions. In practical terms:
For publishers and research organizations (RX), the system offers certainty about the exact extent and nature of AI usage in a manuscript intended for an academic journal article, research report, or scholarly monograph. It enables giving proper credit to the author's own intellectual labor even when AI tools were involved in research and academic writing.
For employers in knowledge-driven industries, workers can safely use AI to extend and improve their output while the system fully credits their personal contributions as an AI collaborator. This transparency builds trust in the authenticity of the work product.
For teachers and students (LX), the software tracks the AI's role as a tutor or assistant in the learning process, measuring the student's effort relative to AI help. Teachers gain insight into how the AI influenced the student's writing and thinking, and students receive feedback on their learning progress, not just the final product.
For medical practitioners and patients (HX), the AI brings comprehensive medical knowledge into the writing of patient notes (e.g., suggesting diagnoses or treatment plans), but the professional's own analysis and decisions are distinctly logged. This ensures accountability for clinical judgments and can support the production with AI assistance of two versions of notes: a technical one for peers and an accessible, empathetic one for patients.

Across these examples and other possible domains, the KX system creates a new standard of transparency in human-AI collaborations. It enables administrators (publishers, educators, managers) to implement accountability policies that give due credit to human cognitive effort while still encouraging the effective use of AI. The outcome is a win-win: humans are recognized for their work even when aided by AI, and AI can be embraced as a powerful tool rather than shunned due to fear of misuse.

In addition, the invention tracks and records peer-to-peer human collaborative effort in knowledge work—much of which today is unpaid or goes unacknowledged (for example, peer review in academia, peer feedback in education, or informal second opinions in medicine). In this case, it tracks the differential contribution in the case of multiply authored works, or works that have be subject to review by people who are not authors. It also tracks human contributions to AI training, such as when an author or reviewer provides feedback that helps refine the AI model (a form of supervised machine learning via human-in-the-loop reinforcement). All of these traditionally unseen contributions, whether human-to-human or human-to-AI, are measured by this system.

Notably, the system quantifies these efforts using a unit of human help or effort called an “Ergon.” Unpaid labor like reviewing a colleague's work, giving feedback, or training the AI (through corrections or Reinforcement Learning from Human Feedback) can earn a user Ergon credits. These credits can then be exchanged or “spent” when the user needs help from others or additional AI resources. Ergons can optionally be bought and sold with conventional monetary currency. This novel credit system incentivizes collaborative knowledge-building and ensures reciprocal value for contributions.

Furthermore, the invention provides AI support at two critical phases of the knowledge production process: drafting and review. In the drafting phase, AI offers:
1) Structural support: helping to outline or format the information architecture of the work (headings, sections, etc.).
2) Epistemic support: assisting content development with features like brainstorming ideas, researching facts, planning sections, expanding text, summarizing content, translating languages, checking logical flow, advising on clarity, and proofreading—all via generative AI suggestions.
3) Semantic support: enabling precise specification of concepts through a novel markup mechanism called “&tag” (described below), which enriches the text with semantic metadata without cluttering the visible content.

The nature as well as the extent of epistemic and semantic support is tracked in the system and included in a report accessible by the system administrator. In cases a writer is using the system without involvement of an administrator, the writer can output a secure document of their draft or finished work with a full provenance report to submit to a third party as a secure PDF, or they can send a link to a web accessible version, such as a publisher, research organization, teacher, health administrator or employer.

In the review phase (after a draft is complete), the invention provides a multi-faceted evaluation process:
1) AI-generated reviews and ratings based on an administrator-defined rubric, giving the creator immediate automated feedback on their work.
2) Human feedback (from peers or administrators—teachers, employers etc.) using the same rubric for consistency. The reviewer is provided AI support and feedback on their review before submission. Reviews can take the form of a global assessment of the work based on the review criteria, and/or annotations that select and highlight specific portions of the work and make comments on them, optionally coded by the review criteria in the rubric. Writers can respond to comments, and in the case of multiple reviewers, reviewers can comment on each others'comments.
3) Comparative moderation where human and AI evaluations are displayed side-by-side and can be calibrated against each other, ensuring fairness and reliability (for example, an administrator can see if the AI graded too harshly or missed an issue a human caught).

Versions are incremented at the start of the review process in order to retain a record of the influence of the review on subsequent revisions, and by version-to-version comparison, the nature of that influence. Writers and rate reviewers and offer feedback on their reviews.

Objects of the Invention. In light of the above, key objectives of the present invention include:
1) Transparent Authorship Attribution: Detect and flag potentially fraudulent representations of intellectual effort in a work by distinguishing AI-generated content and reviewer feedback from the creator's own contributions, and identifying the nature of these contributions.
2) Regulated AI Assistance: Provide specialized AI support to knowledge creators in a controlled manner, so that AI help is useful but does not undermine the integrity of the creator's work.
3) Structured Drafting Support: During drafting, offer embedded AI assistance in three forms—structural (document architecture), epistemic (content development), and semantic (precise meaning through &tags)—to comprehensively support the writing process.
4) Effort Quantification (Ergon): Introduce a non-monetary measure of help, termed Ergon, to quantify and reward human-human and human-AI collaborative efforts in knowledge production.
5) Secure Collaboration Space: Ensure a secure environment for human-AI interaction that meets strict confidentiality requirements (e.g., academic honesty, patient privacy), by isolating the local KX system from external AI services through privacy safeguards and anonymization.
6) Tradeable Credit System: Create a mechanism to credit and exchange the value of collaborative work (both human peer feedback and contributions to AI training) in the form of Ergon units, optionally secured by a blockchain ledger and convertible to traditional currency or other rewards.
7) Semantic Precision (&tag system): Implement an “&tag” semantic annotation system that allows creators to add layers of precise meaning to their content (using a meta-ontology and federated domain ontologies). This reduces ambiguity, mitigates AI hallucination by grounding the AI in clear references, and improves searchability of the content.

### SUMMARY OF THE INVENTION

Overview of the Invention's Architecture: The invention provides a Knowledge Experience (KX) platform composed of three main subsystems working in concert: a KX Administrator, a KX Creator, and a KX Validator. Each subsystem corresponds to a phase or aspect of the knowledge creation process, and together they enable end-to-end support, tracking, and evaluation of AI-assisted writing tasks. In broad terms:
1) The KX Administrator subsystem sets up the knowledge frame for a project. This includes defining the task objectives, establishing an evaluation rubric (potentially for both AI and human feedback), and curating a relevant knowledge base. (Here “administrator” refers to the human in charge of configuration, while “KX Administrator” refers to the software module they use.)

2) The KX Creator subsystem is the workspace where the human creator develops the content (the document, assignment, article, etc.), with AI assistance. This subsystem records all drafting activities and interactions with AI, effectively capturing the provenance and underlying cognitive processes for each piece of content. (“Creator” refers to the human writer, while “KX Creator” is the software environment.)

3) The KX Validator subsystem verifies the provenance of the completed work and evaluates its quality according to the chosen rubric. It combines data from AI evaluations and human evaluations, and measures the relative contributions and effort of the human creator versus AI. The KX Validator may be used by an administrator or reviewer to examine results, and can also provide feedback directly to the creator.

Each of these subsystems contains specialized components to achieve its role, as summarized below. Importantly, the system also incorporates a Zone of Proximal Knowledge (ZPK) mechanism that profiles the individual creator's knowledge level. The ZPK feature ensures that the AI's suggestions and feedback are neither too trivial nor too advanced for the user, but rather calibrated to challenge the user just enough to promote knowledge growth, learning or professional improvement without causing confusion. This dynamic adjustment of AI assistance based on the user's profile is a key inventive aspect of the system's personalization.
1) KX Administrator Subsystem: The KX Administrator is essentially a calibration and setup module for knowledge projects. It allows a knowledge administrator (e.g., a publisher, teacher, or team leader) to define the parameters of a writing task before the creator begins work. Key functions include:
1A) Task Definition: An interface to input the Objectives and Task Description for the project. This is akin to prompt-engineering-clearly specifying what the creator is expected to produce. For example, the administrator sets a title, a narrative description of the task, and specific objectives or requirements. These inputs guide both the human creator and the AI's behavior. The system can assist here by using Generative AI to draft a task description or objectives based on minimal input from the admin, which the admin can then edit.
1B) Rubric Creation: A tool to create or select an evaluation rubric for the task. The rubric consists of criteria that will be used to evaluate the work (either by humans, by the AI, or both). The administrator can manually define each criterion (name, description, weight, and performance levels with descriptions), or invoke the AI to automatically generate a draft rubric based on the stated objectives and any provided reference materials. The rubric is stored and can be reused or shared. (Rubrics can be kept private to an organization or published for others to use, with version tracking if modified by others.) Embedded in this rubric tool are metaprompts that translate each criterion into a form that the AI can understand and evaluate. For instance, if the rubric criterion is “Clarity of Argument,” the system will have a detailed prompt template to ask the AI to rate and justify clarity in the text.
1C) Knowledge Base Integration: An interface to build or attach a domain-specific knowledge base relevant to the project. The administrator can upload documents or provide links (papers, textbooks, corporate documents, etc.) that the AI should draw upon when assisting the creator. The system processes this material into a vectorized form for efficient Retrieval Augmented Generation (RAG) or Cache-Augmented Generation (CAG). This ensures that the AI's suggestions and feedback are grounded in accurate, context-specific information rather than generic knowledge. If no custom knowledge base is provided, the AI will rely on its foundational model knowledge. The admin can also link domain ontologies (including adding to the metaontology used by &tags) to guide the AI's understanding of specialized terminology.

These elements together form the “knowledge frame”—the contextual scaffolding for the project. The KX Administrator subsystem may allow automatic configuration through AI (for example, given a few inputs, it can suggest objectives, rubric, and knowledge resources), but always with human oversight and editability. The output of the Administrator phase is a packaged project description that includes the task orientation, rubric, and knowledge base pointers, which can then be handed off to a creator (or multiple creators) to work on.
2) KX Creator Subsystem: The KX Creator is the content creation environment where the human user composes the document with AI assistance. It is typically a rich text editor augmented with special toolbars and tracking functionality. The KX Creator subsystem provides three main mechanisms to the user, in one possible embodiment implemented as floating toolbars in the UI:
2A) Structure Toolbar: This offers standard editing and formatting options to organize the document's structure (for example: bold, italics, underline, headings of various levels, list formatting, inserting tables, indenting quotes, adding hyperlinks, embedding images or other media, and inserting references or citations in proper format). While this might resemble a normal word processor's toolbar, it's enhanced by the system's capability to log structural actions as part of the contribution record. For instance, adding a heading or rearranging sections is noted as the user's structural contribution to the work's information architecture. The structure markup can also be translated to HTML or other formats behind the scenes.
2B) Epistemic AI Helper Toolbar: This is a suite of Generative AI-powered functions to assist with content creation and editing. The creator can select text (or leave nothing selected to refer to the whole document) and invoke functions such as:
   Brainstorm: The AI generates ideas or starting points related to the selected text or the given topic.
   Research: The AI conducts a web or knowledge-base search and returns summaries or relevant information (with sources, if available) to inform the creator.
   Plan: The AI suggests an outline or logical structure for a section or the whole piece.
   Expand: The AI proposes additional text to elaborate on a point the creator has made (useful for fleshing out a draft).
   Summarize: The AI condenses a selected portion of text, suggesting a shorter version or main takeaway (the creator can use this to tighten prose or create abstracts).
   Translate: The AI translates the selected text into another language.
   Check Flow: The AI analyzes the logical flow or coherence of the essay/argument and points out any jumps or inconsistencies, potentially suggesting transitions or reordering.
   Advise: An open-ended query function where the creator asks the AI for advice (e.g., “How can I make this section more persuasive?”).
   Proofread: The AI highlights grammar and spelling issues and can suggest corrections with explanations.

Each of these functions is driven by carefully designed prompts behind the scenes (the embedded metaprompts), so that the AI's output is tailored to be maximally helpful. For example, the “Proofread” function's prompt might instruct the AI to act as a copy-editor and not only correct errors but explain the reasoning, aiding the creator's learning. The system logs each invocation of these tools: what suggestion was made by the AI and whether the user accepted or modified it, contributing to the contribution ledger.
2C) Semantic Web (“&tag”) Toolbar: This mechanism allows the creator to annotate their content with semantic tags (denoted as &tags), adding an invisible layer of meaning, linking &tags to external knowledge graphs (e.g., DBpedia, Schema.org, Wikidata) for enriched contextual understanding and providing a tag suggestion history for reuse across projects. The toolbar taps into the Common Ground Markup Language (CGML) meta-ontology which comprises top-level semantic categories (e.g., Reference entities like people, places, or documents; Agency such as actions or processes; Structure for document elements; Context like time or location markers; Interest indicating sentiment or emphasis, etc.). Under this meta-ontology, various domain-specific ontologies can be federated.

When using the semantic toolbar, the creator might highlight a term or phrase in the text and choose to tag it. For instance, highlighting a person's name could bring up an option to tag it as a Person entity, possibly linking to a unique identifier (like an ORCID for an author). A conference name might be linked to a specific event entry (with date and place). An ambiguous term can be disambiguated by linking it to a concept entry from a relevant ontology or database. The system can also automatically suggest &tags for the whole document—essentially an AI-driven entity/keyword recognition across the text—which the creator can review and accept or refine. These tags can be hidden or shown as inline notations (e.g., a term might display as “Phillip Kalantzis-Cope (&ORCID: 0000-0001-6256-052X)” when tags are visible). They do not alter the main text content but are stored as metadata. The benefit of &tags is twofold: it increases semantic precision, helping to mitigate AI misunderstandings or hallucinations by grounding concepts in known references, and it enables rich post-processing such as generating a knowledge graph of the document or improving search indexing. Tags added (whether by AI suggestion or human) are also part of the contribution record.

Throughout the writing process in the KX Creator, the system's Contextual AI tracking is silently at work. Contextual AI, as used herein, refers to the system components and processes responsible for monitoring, logging, and analyzing user interactions and content provenance within the workspace. By these means, the system captures a highly granular log of events: every keystroke and mouse action, content added or deleted, timestamps of activity, which toolbar functions were used and their outcomes, the kind of action (e.g. the way the AI is used, planning vs proofreading in the case of AI, or humans responding to a particular rubric prompt or annotation code) etc., assigning unique identifiers to each contribution event for precise auditing and exporting this data in standardized formats (e.g., JSON, CSV) for external analysis. It can integrate signals from beyond the editor if allowed—for example, checking if text was copy-pasted from an external source (and if so, prompting the user to verify its origin), or recording if the user looked up certain sources (via clickstream or browser data, where privacy settings permit).

Biometric or behavioral authentication can be an optional part (e.g., ensuring the logged-in user is physically present via webcam, or recognizing the user's typing patterns) to prevent impersonation. All of this contextual data serves as a proxy for the human's cognitive effort, forming the basis of later analysis by the KX Validator.

In cases where creators enter the KX Creator subsystem without the supervision of an administrator (a human publisher, teacher, medical informatics administrator, or some such person who has configured the system for a specialized use), the KX Administrator system will be configured by default to a generic task definition, rubric, and knowledge base. Alternatively, the creator will be able to select a specialized task definition, rubric, or knowledge base that has been made publicly available, having been published in the system. In other words, writers will be able to enter the system directly and benefit from its features immediately even when they are using the system independently of an administrator (teacher, publisher, employer etc.). They will be able to export their work as a securely locked document with a provenance certification report, or send a link to a third party such as a teacher, publisher, or employer who does not have an account on the system.
3) KX Validator Subsystem: The KX Validator is engaged when a draft is ready to be reviewed and evaluated (this could be after the first draft or after multiple revisions). This subsystem has several important roles:
3A) Provenance Verification: Provenance Verification: Using the detailed logs from the Creator subsystem, the Validator generates a report on the relative contributions of human vs. AI in the document, rendered through a display module that includes a timeline slider to scrub through the document's evolution and an accessibility mode with high-contrast visuals and screen-reader compatibility. It can also produce a digitally signed contribution summary certificate with timestamps and other summary data providing an account of the processes of creation of the document and the work undertaken in its creation. It analyzes the document segment by segment, summarizing what percentage or portions of the text originated from AI suggestions (and possibly to what extent those suggestions were later edited by the human) versus what was originally written by the human. It also accounts for any external content (e.g., pasted text)—flagging those and requiring the creator to certify the source (to catch plagiarism or reuse of one's own prior work). The result can be presented as an overall “AI Assistance Percentage” or a timeline of the writing process highlighting who (or what) contributed what. When human reviewers (non-authors) are involved, their contributions are also tracked. Also, the nature of the AI and human reviewer support is tracked (for instance, the influence of “brainstorming” versus “proofreading” in the case of AI support, or human reviewers responding to a specific criterion in the rubric or annotation code). This provenance data gives a unique digital fingerprint of the work's creation. If required, the system can output a secure, signed report or append metadata to the final document (e.g. in a PDF) verifying the authenticity and authorship distribution of the content.
3B) Effort and Ergon Calculation: The Validator quantifies the effort in terms of Ergons, with a tiered reward system awarding bonus Ergons for high-quality contributions (e.g., original research) and a decay function reducing unused Ergon value over time to encourage participation. It computes human effort not just by raw time or keystrokes, but by comparing to how much effort an equivalent result would require from a human alone. It calculates the AI's contribution in “Human-Equivalent Ergons.” For example, if the AI quickly generates a five-paragraph summary, the system might estimate how much effort (in time/complexity) it would have taken a human to produce the same output—and count that as the AI's effort counterpart. By doing so, the system can report something like: “Human contributed 70 Ergons, AI contributed 30Ergons for this project.” An Ergon is the equivalent of an hour, meaning the human effort was 70 hours, and the AI system effort was equivalent to 30 human hours. When multiple human creators collaborate on the same document, either as co-creators or as non-authoring reviewers, the system can similarly break down Ergons per person, attributing an Ergon effort credit to each.
3C) Automated AI Review: The Validator uses the rubric from the Administrator phase to conduct an AI-driven review of the content. Each criterion in the rubric is fed (along with the work) as a prompt to the Generative AI engine. This is done in a multi-pass manner: if there are n criteria, the AI will read the entire work n times, each time focusing only on one criterion. For each criterion, the AI provides a quantitative rating (e.g., a score or level achieved) and a qualitative justification (textual feedback explaining the score and suggesting improvements). The system compiles these into an AI review report that covers all rubric criteria. This process gives immediate, consistent feedback and can catch issues that align with the rubric definitions.
3D) Human Reviews and Annotations: In parallel or subsequently, human reviewers (peers, instructors, editors, or the creator themselves for self-assessment) can also evaluate the work using the same rubric. The Validator subsystem provides an interface for reviewers to input ratings and comments per criterion. It also supports annotation of the text—inline comments or highlights that the creator can view. The system can enforce anonymity settings if configured (e.g., blind peer review). All human feedback is recorded in the system.
3E) Human-AI Moderation: A unique feature is the ability to moderate AI and human feedback against each other. The Validator can present the AI's ratings next to the human's ratings for each criterion, making it easy to spot discrepancies. If the AI rated something 5/5 but a peer rated it 3/5, the administrator, creator or the AI can investigate why. The system also allows creators to give feedback on the feedback: the creator can rate the usefulness of a peer's review or an AI's comment. This creates data on reviewer reliability and helps calibrate trust in AI vs. human judgments. Human reviewers can also call up AI feedback on their reviews before submitting. Over time, this data can feed back into improving the AI (via reinforcement learning on its review style) and identifying which human reviewers give overly harsh or overly lenient scores. In effect, the system monitors inter-rater reliability, so performing a meta-evaluation to ensure fairness and accuracy of evaluations.
3F) Epistemic Progress Evaluation: Especially useful in educational or iterative writing settings, the Validator tracks the evolution of the work. It can compare successive drafts or measure how the work improved after taking into account reviews. It also maintains a profile of the creator's skill development across projects—for instance, tracking if a student's writing is showing better structure or clarity over time. In an educational embodiment, this ties into the ZPK concept, helping tune future AI assistance to the learner's growth or the extent of the employee's current knowledge. Progress evaluation results (like improvement metrics or difficulty levels tackled) can be visualized and exported (e.g., to an LMS gradebook or student progress report, or an employee professional growth and performance report).

All these functions of the Validator subsystem operate within a privacy-aware framework, incorporating multi-factor authentication (e.g., biometric or hardware tokens) for user logins and a data anonymization feature stripping personally identifiable information from logs for research purposes. The system ensures that any data sent to external AI services (for generating reviews or suggestions) is stripped of personal identifiers and sensitive content where appropriate (secure anonymization). Moreover, in secure installations (such as on-premises in a hospital or a closed academic network), the KX system can use a dedicated or local AI model to avoid sending data out at all.

In summary, the KX Validator confirms how a piece of knowledge content was created and assesses how good it is, synthesizing machine analysis with human insight. The end result could be a comprehensive report or dashboard for the administrator or creator, showing (for example) an aster plot chart of human vs AI contribution, the rubric scores from AI and humans, a list of top strengths and weaknesses identified in the work, and even a certificate or badge indicating the authenticity of the work's creation process.

Novel Integrated Mechanisms: The synergy of these three subsystems yields several key innovative mechanisms that distinguish this invention from prior art:
1) Generative+Contextual AI Combination: The system marries generative AI (which provides content suggestions and feedback) with contextual AI (which monitors user activity and context) in a tightly integrated loop. For instance, as the generative AI helps the user, the contextual AI logs that help and its usage. This integration allows the platform to adjust the AI's behavior based on the user's actions (e.g., if the user keeps rejecting a type of suggestion, the AI can learn to stop offering it), and to produce a verified account of how much the AI contributed.
2) Real-Time Contribution Ledger: Every action in the KX Creator updates a contribution ledger that flags content with its origin (AI or specific human author) and tallies contributions. This ledger concept goes beyond simple document versioning; it quantifies the creative process. It can attribute even fine-grained contributions (like a particular sentence coming from an AI “expand” suggestion vs. a paragraph written manually). This real-time tracking is the basis for computing contribution ratios and Ergons.
3) Ergon Credit System: By translating collaborative actions (peer reviews, AI training inputs, etc.) into Ergon units, the system establishes a secondary economy of knowledge work. Unlike typical user points or badges, Ergons have a practical exchange value: a student who reviews others'work could earn Ergons that exempt them from some tasks or give them additional AI resources; a researcher who helps train the AI on domain data might use earned Ergons to get extra editing support. This encourages active engagement and balanced give-and-take in communities using the platform. It may also be possible to buy and sell Ergons using regular currency.
4) Semantic Enrichment (&tags): The introduction of &tags means the content being created isn't just plain text—it's text with a scaffold of meaning that machines can interpret in depth. This is especially useful to combat AI hallucination: if the AI has access to a semantically rich version of the text (with &tags linking to real entities and concepts), it is less likely to make things up or confuse one entity for another. Additionally, the &tag system can feed into improved search and knowledge graph generation, as mentioned. The presence of &tags during AI generation means the AI can double-check its outputs against a structured understanding of the content.
5) Secure AI Integration: Recognizing that many use-cases involve sensitive data (unpublished research, student data protected by privacy laws, patient records under HIPAA, legal documents etc.), the system is designed to maintain a secure boundary. All communication with external AI models (if used) can be anonymized or even omitted in favor of on-site models. This architecture ensures the benefits of state-of-the-art AI can be applied in regulated environments that normally could not use consumer-grade AI tools due to data leakage concerns.

Improvements Over Existing Technology: Compared to the current state of the art, this invention provides several advancements:
1) Granular Authorship Tracking: It gives creators and administrators unprecedented, highly granular information about who (human authors, reviewers, or AI) did what in the writing process. This reliable data on representational work is a leap beyond the opaque operation of existing AI writing tools.
2) Epistemically-Oriented AI Prompts: The system's embedded metaprompts ensure the AI's contributions are epistemically rich-meaning they are context-aware and aligned with knowledge-building (e.g., giving constructive feedback or multi-perspective advice) rather than generic text output.
3) Domain-Specific AI Calibration: Knowledge administrators are empowered with tools to finely calibrate AI feedback to specialized contexts (via custom rubrics and knowledge bases). Unlike one-size-fits-all AI assistants, this system adapts to disciplines (research, education, medicine, etc.), providing relevant and moderated AI evaluations.
4) Contextual AI Integration: The invention goes beyond standalone generative AI by integrating contextual AI to track the process. For example, while generative AI offers helpful suggestions during drafting and review, contextual AI simultaneously verifies the human's engagement and contributions. No conventional writing system combines these in real-time.
5) Semantic Precision with &tags: By adding a layer of semantic precision through &tags, the system mitigates the issue of AI “hallucination” (making up facts or misidentifying references). The AI has access to a disambiguated, ontology-linked context, making its suggestions and critiques more trustworthy.
6) Bridging Paid and Unpaid Knowledge Work: The introduction of the Ergon currency bridges the gap between traditionally uncredited labor (such as peer review or AI training) and formal recognition. It creates a tradable credit system reflecting actual cognitive effort, something not addressed in prior knowledge economy tools.

### BRIEF DESCRIPTION OF DRAWINGS

FIG. 1 shows the relation of KX Knowledge Experience to a range of possible embodiments.

FIG. 2 shows the phases in the staged operation of the invention.

FIG. 3 shows method by which the KX Administrator system establish the parameters for knowledge activity.

FIG. 4 shows the Task Orientation and Objective Setting components and organization of the KX Administrator system.

FIG. 5 is a screenshot the overall setup of the Rubric subsystem.

FIG. 6 is a screenshot of the Criterion specification area within the Rubric subsystem.

FIG. 7 is a screenshot of the Rubric selector.

FIG. 8 shows the functions of the Knowledge Base maker.

FIG. 9 illustrates the components and functions of the Project creator.

FIG. 10 shows alternative pathways into the KX administrator.

FIG. 11 shows the KX Creator subsystem with its Structure, Epistemic Helper, and Semantic Web mechanisms.

FIG. 12 illustrates the mechanism of federation of multiple ontologies into Common Ground Markup Language (CGML).

FIG. 13 is a screenshot of a knowledge graph based drawn from the CGML metaontology.

FIG. 14 illustrates the principal functions of the KX Validator system.

FIG. 15 is a screenshot showing the review Rubric during the drafting phase.

FIG. 16 is a screenshot of human Review feedback.

FIG. 17 is a screenshot of human Annotation.

FIG. 18 is a screenshot of a Work ready for AI review.

FIG. 19 is a screenshot of an AI review.

FIG. 20 is a screenshot of a Survey in the KX Validator system.

FIG. 21 illustrates the system of Human-AI Feedback Moderation.

FIG. 22 illustrates the relations of Generative AI and Contextual AI in the Provenance Validator

FIG. 23 demonstrates the system and method for determining Ergons.

FIG. 24 illustrates the privacy and security aspects of the KX system.

FIG. 25 depicts a typical workflow for an LX (Learning Experience) project in the system.

FIG. 26 illustrates a paradigm shift in educational technology enabled by the LX system.

FIG. 27 shows the left-right split screen architecture of the KX Creator interface.

FIG. 28 is a screenshot of an individual progress assessment visualization for a learner.

FIG. 29 illustrates a health condition knowledge graph in the HX (Health Experience) embodiment.

### DETAILED DESCRIPTION OF THE INVENTION

In the following description, references like “101”, “202”, etc., refer to elements in the figures listed above. The terms “KX Administrator,” “KX Creator,” and “KX Validator” correspond to the major subsystems of the invention, and “&tag” refers to the semantic tagging mechanism described.

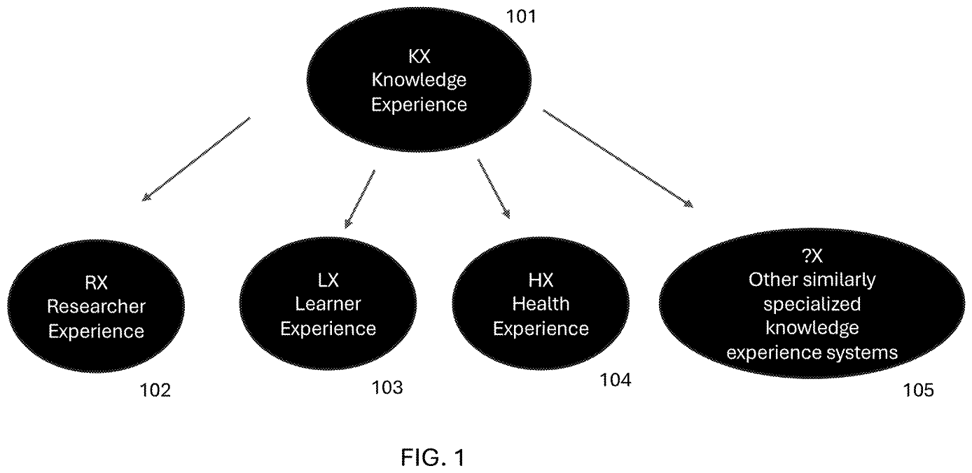

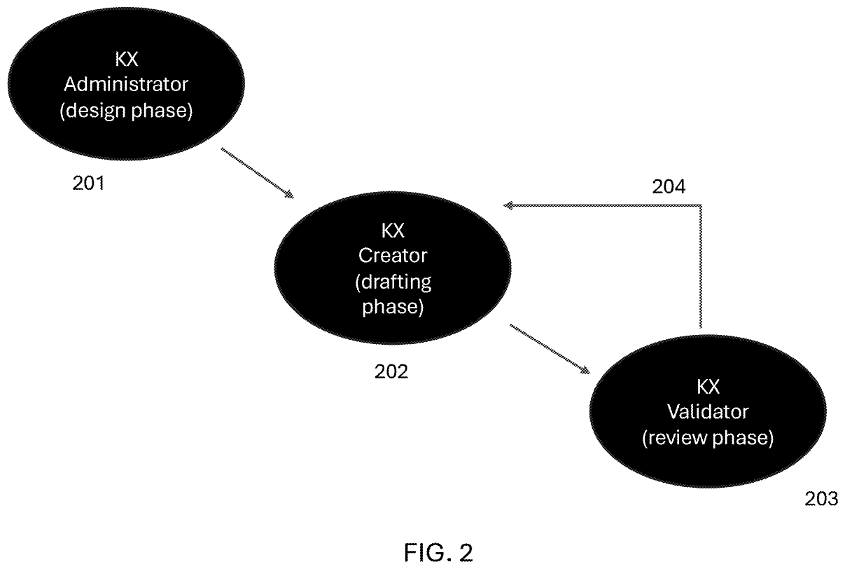

General System Architecture (FIGS. 1-2) In one embodiment, the writing application (the KX system) runs on a user's computing device (e.g., a PC or tablet) and connects to one or more AI services which may be cloud-based. The overall KX Knowledge Experience platform can be instantiated for a variety of knowledge creation and evaluation contexts (as depicted in FIG. 1). In general, the platform supports at least three roles: a knowledge administrator (who designs and deploys the writing task and its parameters), one or more knowledge creators (who carry out the writing task), and reviewers/evaluators (who may be peers or supervisors providing feedback, as well as the system itself providing AI-driven evaluation).

Referring to FIG. 1, the general embodiment of the invention KX Knowledge Experience 101 encompasses a variety of applications across a wide range of knowledge creation and evaluation sites. This general embodiment encompasses a number if specific embodiments, including: RX Researcher Experience 102, suitable for research organizations and publishers; LX Learner Experience 103, for formal and informal education settings; HX Health Experience, for medical practice 104; and ?X indicating other such similarly configured knowledge creation and evaluation sites 105.

In FIG. 2, the relations between three essential functional components or subsystems of the invention are shown: a KX Administrator tool for the project design phase 201, a KX Creator area for the drafting phase 202, and a KX Validator for the review and evaluation phase 203. The relationship between the KX Creator and KK Validator can involve multiple cycles of evaluation and revision 204.

FIG. 2 provides a schematic overview of how these roles interact across three functional components: The project design phase 201 is handled by the KX Administrator tool, where an administrator sets up the assignment or project parameters (task guidelines, rubric, knowledge base, etc.). The drafting phase 202 in the KX Creator area, where the human creator writes the content with optional AI assistance and the system logs all actions. The review and evaluation phase 203 in the KX Validator, where the work is subjected to AI review and/or human reviews according to the prepared rubric. Notably, FIG. 2 also indicates that the KX Creator and KX Validator can engage in multiple cycles 204—meaning a creator might revise their draft based on feedback and resubmit for further review, a loop that the system supports seamlessly. Throughout the process, a comprehensive log of events is maintained. The client application (running on the user's device for the Creator role) includes a monitoring component that constitutes the Contextual AI aspect of the system. This component records each user activity (such as keystrokes, content edits, use of AI suggestions, etc.) into a contribution log stored either locally or on a secure server. This log, together with AI-generated content records, forms the basis for later validating the provenance of the content.

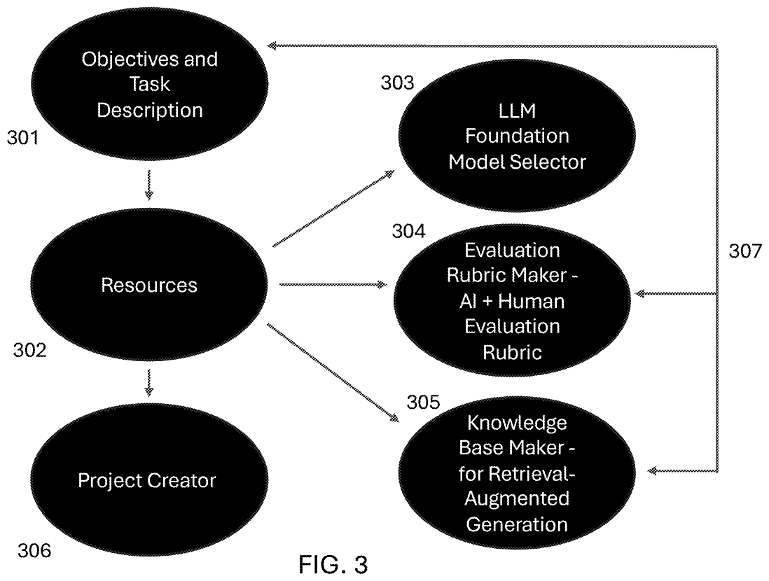

KX Administrator Subsystem (FIGS. 3-10): The overall architecture of first of the three major subsystems for knowledge creation support and evaluation is the KX Administrator is illustrated in FIG. 3. Using the KX Administrator system, a knowledge administrator such as a publisher, teacher, or health administrator sets Objectives and Description 301, specifies the Resources to be used in support of the activity 302 including the Foundation LLM 303, the evaluation Rubric 304, and Knowledge Base 505. Foundation LLMs may include those accessible via Application Programming Interface (API), or a foundation LLM otherwise provided to the subsystem by the administrator. These Task Objective and Resources are the are then assembled into the Project creator 306. The KX Administrator settings can be created manually through a series of forms or created automatically by the Generative AI by means of a series of metaprompts embedded in the KX Administrator subsystem. As illustrated by the arrows 307, among other automatic generative mechanisms, a Rubric can be created from Objectives and Task Descriptions, or a Knowledge Bank developed by means of an automated web search based on Objectives and Task Descriptions, or a Knowledge Objectives and a Rubric created from a Knowledge Bank and may other such permutations. Machine-generated Objectives and Task Descriptions, Knowledge Banks and Rubrics can be edited and revised by administrator.

Referring to FIG. 3, in functional and process terms the KX Administrator subsystem provides an interface through which a knowledge administrator (e.g., an instructor, editor, or manager) configures a new knowledge project. The administrator sets Objectives and Description 301 of the task—essentially telling the system (and the eventual human creator) what needs to be done. They also specify Resources 302 that will support the task: 1) selecting a foundation LLM 303 (if multiple AI models are available, the admin can choose the one most suited, or select a default); 2) attaching an evaluation Rubric 304 (either by creating a new one or choosing an existing template); 3) Compiling a Knowledge Base 305 of reference materials for RAG or CAG. These configurations are then encapsulated into a Project definition 306. The system supports both manual setup and AI-assisted setup. For instance, an administrator could fill out forms step by step, or they could input minimal information and let the system auto-generate parts of the setup. FIG. 3's arrows 307 illustrate some of these automated flows: the system can generate a draft Rubric from the Objectives and Description, or conversely propose Objectives and a Description based on a given Knowledge Base, etc. All machine-generated configurations are editable by the administrator before finalizing.

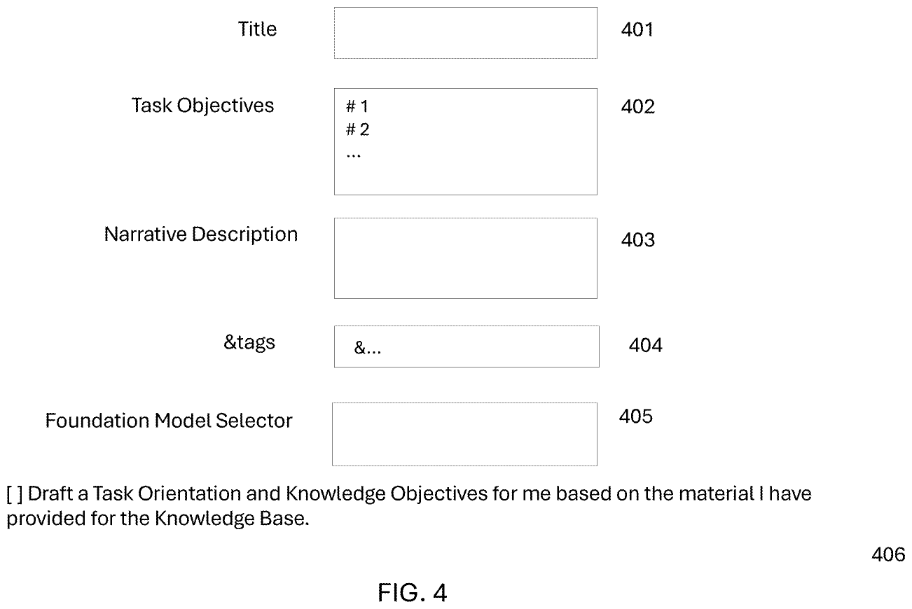

Moving to FIG. 4 (the Task Orientation interface), the administrator enters specifics like the Task Title 401, Objectives 402, and a narrative Description 403. There is also an interface to browse or search the &tag ontology 404 to attach relevant tags (e.g., subject domain tags, key concepts) to the project—this helps contextualize the task for both human and AI. The administrator selects the preferred foundation AI model 405 if applicable. A notable feature is option 406: a toggle for AI assistance in drafting the task definition. If enabled, the system will use generative AI to suggest a draft task description and objectives (based on any materials the admin might have placed in the knowledge base or context), which the admin can then refine. This streamlines the project setup, especially useful if the admin has provided background docs—the AI can summarize them into an assignment prompt.

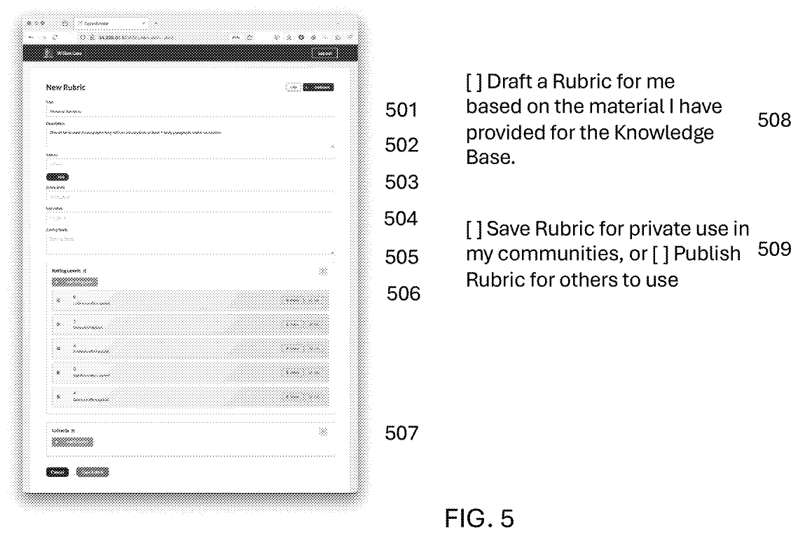

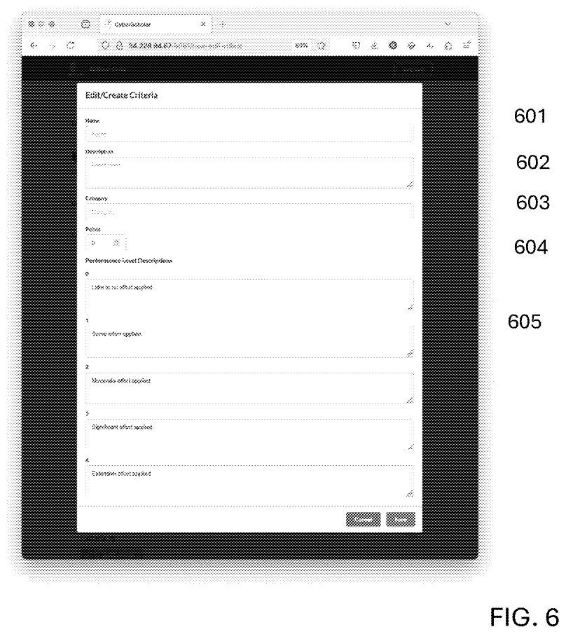

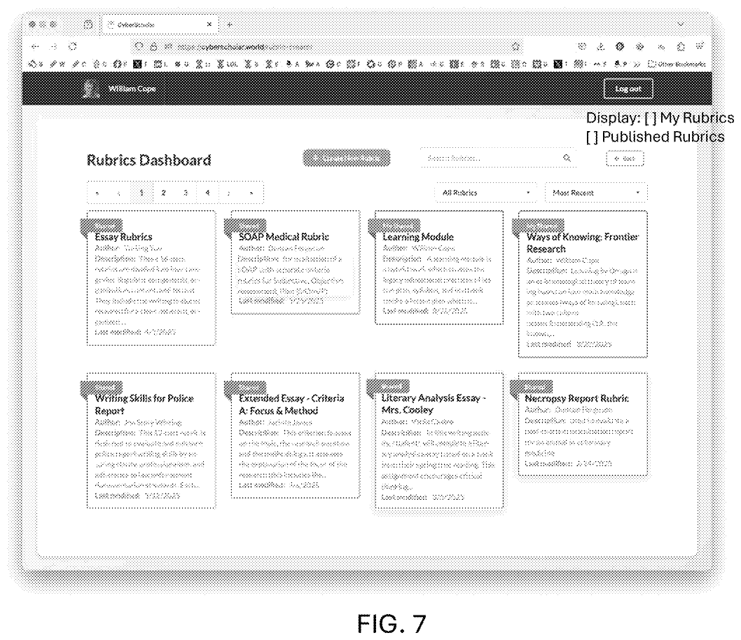

FIGS. 5 and 6 detail the Rubric subsystem. FIG. 5 shows the way in which the KX Administrator subsystem manages the construction of an evaluation rubric, to be deployed automatically for AI-constructed reviews, manually for human reviews (self, peer, administrator), or automatically for human-AI moderation. The option is provided to the human administrator for the AI to draft the Task Orientation and Knowledge Objectives based on the material they have provided for the Knowledge Base 508. The components of the Rubric mechanism include details such as Title 501, Description 502, Creator of the Rubric (auto-populates from the administrator's profile), Date Created (created at time of save), Subject 503, Grade or Education Level 504, Organization or Institution, and Scoring 505, and Scoring Guide 506. The administrator can determine the number of rating levels and begin to add criteria 507. The administrator can save their Rubric for private use in their own online communities or publish for others in the system to use 509. In the process of the admin can specify how many performance levels each criterion will have (point ranges or descriptive levels like “Excellent/Good/Fair/Poor”). The AI drafting option 508 appears here as well—the admin can ask the AI to populate the rubric with criteria based on the provided objectives or knowledge base. For example, if the assignment is a persuasive essay, the AI might suggest criteria like “Thesis Clarity,” “Evidence and Support,” “Organization,” etc., each with descriptions. The admin can accept, modify, or delete these suggestions. Completed rubrics can be saved; a My Rubrics vs. Published Rubrics view (FIG. 7) lets admins reuse their own rubrics or adapt ones shared by others.

In FIG. 6, we see an individual Criterion editing interface. For each criterion, the admin defines the name 601 (e.g., “Clarity of Writing”), a description 602 (what that entails), an optional category 603 (to group criteria, e.g., “Content” vs “Writing Mechanics”), and a weight or points 604. Then, for each performance level (which might be numeric scores or labels), a description 605 can be given (e.g., what constitutes “Excellent” clarity vs “Poor” clarity). The system, when running an AI review, will take each criterion and formulate a separate prompt to the AI. This design (treating each criterion as an independent evaluation query) ensures the AI focuses on one aspect at a time, leading to more structured and thorough feedback. If there are, say, 5 criteria, the AI will effectively “read” the work 5 times, each with a different lens.

In functional and process terms, FIG. 6 illustrates the construction of a single Criterion, whether automatically generated by the AI apparatus, or edited from the AI by the administrator, or manually entered by the administrator. Variables include Criterion Name 601, Description 602, Category 603, the weighting attributed to the that criterion expressed in points 604, and the specific description of performance levels 605. When AI reviews are run, each Criterion is presented to the AI as a separate prompt. This means that the Rubric engine divides each criterion into a separated and independent prompt for the AI. In other words, if there are n criteria, during the review phase the AI will pass over the work under evaluation n times, providing quantitative rating and qualitative feedback against that criterion.

Because crafting effective rubrics (especially ones that double as good AI prompts) can be challenging, the system's rubric tool includes hidden metaprompts and guidance. For instance, when the AI is to evaluate a criterion, the underlying prompt might add instructions such as: “Provide constructive criticism and at least one suggestion for improvement,” or “Consider multiple perspectives if applicable,” or “Use a formal tone appropriate for feedback.” These are by default hidden from the interface to keep it clean, but power users (admins) can reveal and edit these advanced settings if needed.

FIG. 7 is a screenshot of available Rubrics, divided into My Rubrics 701 for use in private knowledge communities and Published Rubrics or rubrics shared by other system users 702. Other users'Rubrics can be edited for use in private knowledge communities, with details of modifications noted—editor, date, changes. Once a rubric is ready, FIG. 7's list shows how rubrics are stored. Users can click on a published rubric to fork it (make a copy) for their own use, with the system logging provenance (original author and modifications). This encourages sharing of best-practice rubrics while maintaining credit.

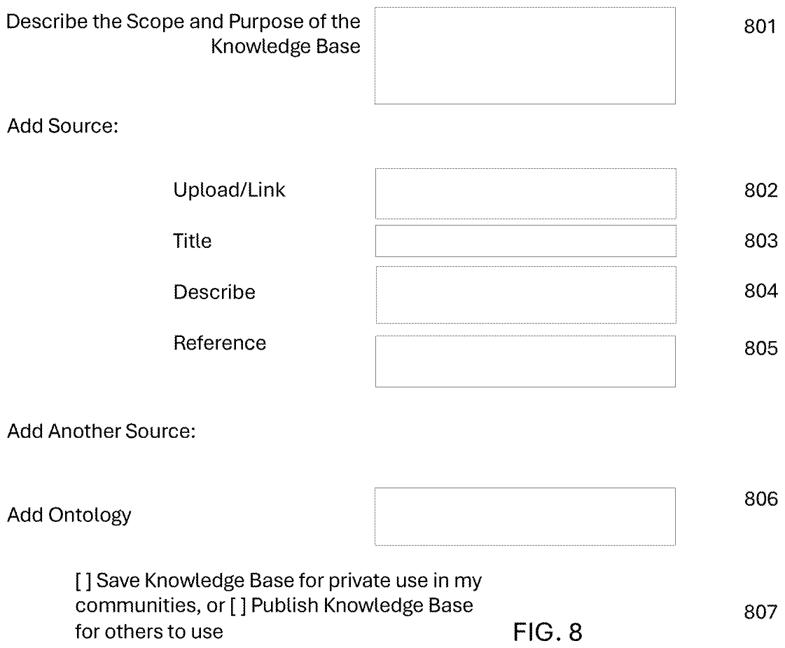

Another part of KX Administrator is the Knowledge Base maker, shown in FIG. 8. This captures digitized content selected by the administrator as relevant to the knowledge work at hand. This might include administrator notes, slide presentations, articles, books, videos, websites and such like. The administrator specifies the scope and purpose of the knowledge base 801, then adds sources, one by one uploading files or linking to external sources 802. The system uses AI title 803 and describe each source 804, and where possible to provide a formal reference 805. The administrator can also fine-tune their Knowledge Base by adding domain-specific ontologies, or the federated metaontology, CGML 806. The administrator has the option to save their Knowledge Base for private use in their knowledge communities or publish their knowledge base for the private use of others in the system 807. When using a Knowledge Base created by another administrator, details of modification are recorded including the name of the modifier, date of modification, and changes made.

In process terms, the administrator first defines the scope/purpose 801, which might be a short description like “Background readings for Topic X.” Then they add sources one by one: either uploading files or providing URLs 802. The system tries to automatically fetch or summarize metadata for each source: generating a title 803 and description 804, and retrieving or formatting a reference 805 (such as a citation in APA/MLA style, if possible). The administrator can override or edit these. All added content is then processed by the system: text is extracted and turned into embeddings for the vector database. If the admin included videos or non-text media, transcripts or metadata might be used similarly. The administrator can also integrate the CGML ontology 806 by selecting relevant sub-ontologies that apply to this knowledge base (for example, adding a Medical ontology for a health-related knowledge base). Once built, the knowledge base can be saved privately or published for others 807, with versioning if someone else modifies it later.

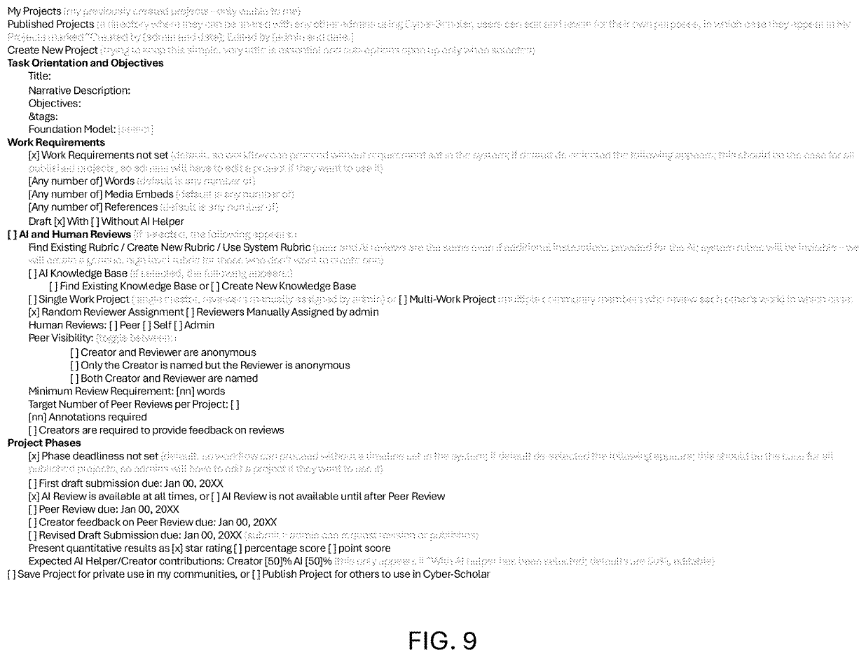

FIG. 9 depicts the Project Creator assembly screen, consolidating all earlier pieces (Objectives, Rubric, Knowledge Base, and other settings like deadlines). The system auto-fills much of it if those subsystems were completed: for instance, once you choose a rubric and knowledge base, those are attached to the project; if you've written objectives, they appear here. The admin can specify Work Requirements (e.g., “at least 1500 words, include 5 references, embed 2 images”). They also decide if the AI helper is enabled during drafting—some scenarios might forbid AI assistance until after an initial draft to encourage originality. The Review settings in project creation allow the admin to configure:
Is it a single-creator project reviewed by assigned reviewers, or a multi-creator project with peer review rounds?
For multi-creator (like a class of students each reviewing peers), will reviews be randomly assigned or manually assigned?
What types of human reviews are required (peer review, self-review, instructor/admin review)?
Reviewer anonymity options.
How many peer reviews each creator must do and how many they should receive.
Minimum length of reviews (to prevent cursory feedback).
Whether creators must also provide feedback on the reviews they got (closing the feedback loop).
If AI assistance is available to reviewers (the admin might allow peer reviewers to get AI suggestions to improve the quality of the reviews they write).

The admin can also set phase deadlines (FIG. 9 shows fields for due dates of first draft, peer review, revisions, etc.), though by default these might be open-ended if not set. After all configuration, the project can be saved (for reuse in the future) or published (to invite participants). Published could mean the admin explicitly invites specific users or makes it available to a community (like posting an assignment link in a class).

After submission, an administrator can request further revision or publish the finalized work. The administrator can also determine whether AI Review is available at all times, or not available until after Peer Review has been completed. The quantitative results of the AI and human reviews can be presented as a star rating, a percentage score, or a point score depending on administrator selection. The administrator can also set expectations regarding relative AI and human contributions to the final knowledge product. When the creator receives the AI review, they can adjust language level (for instance expressed as grades 4 to 20) and expertise levels (for instance: novice, competent, proficient, expert, and knowledge leader) to align with their level of understanding of the domain. Finally, it is possible to save a Project for private use in the administrator's knowledge communities, or Publish the for others to use in the system.

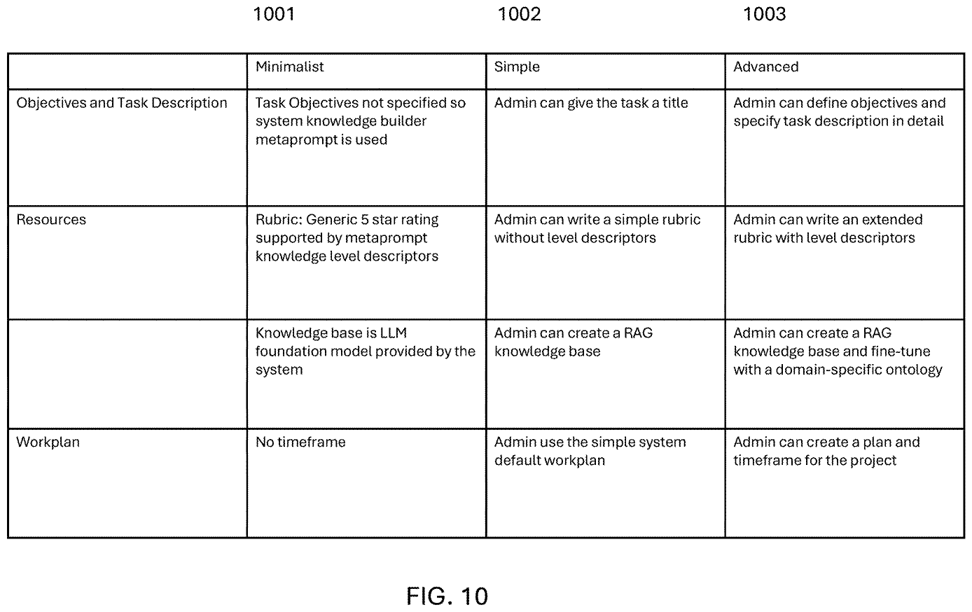

FIG. 10 visualizes different pathways or usage modes for the admin interface, Minimalist 1001, Simple 1002, and Advanced 1003 pathways. For instance, a “Minimalist” path might involve using system defaults (like a standard rubric and no custom knowledge base)—quick setup. A “Simple” path might involve picking from templates and slight customizations. An “Advanced” path would involve thoroughly customizing objectives, rubrics, knowledge bases, etc. This caters to various user skill levels and needs.

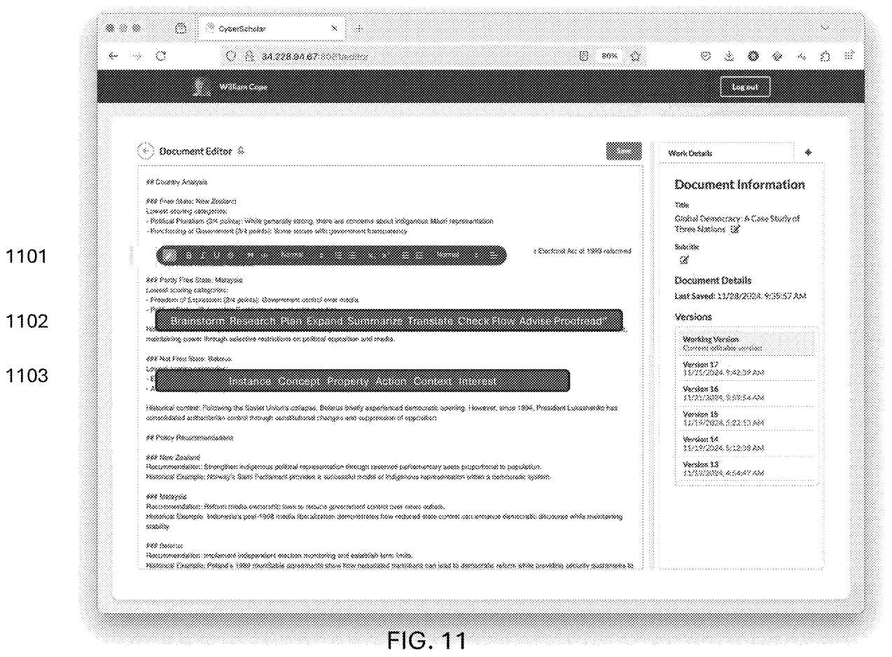

KX Creator Subsystem (FIGS. 11-13): KX Creator is the second major subsystem in the KX Knowledge Experience system. It can be entered directly for the Creator to use with system Rubrics, or it can be entered on the invitation of an administrator who has created and shared, publicly or privately to their knowledge community, a stand-alone statement of Objectives and Task Orientation and Resources in the form of a Rubric and/or Knowledge Base. Alternatively, the administrator might issue an invitation to undertake a Project as designed in the KX Administrator area. The KX Creator subsystem consists of three mechanisms in the present to creators in the form of floating toolbars as illustrated in FIG. 11: a Structure toolbar 1101, an AI powered Epistemic Helper toolbar 1102, and a Semantic Web toolbar 1103. After an administrator publishes or shares a project, a creator (writer) can start working in the KX Creator subsystem. In some cases, creators can also launch the KX Creator on their own (using a default rubric and knowledge base from the system if no custom project is provided), for freeform use of the AI writing assistant.

The Structure mechanism 1101 offers options such as B I U S, Indented Quote, Link/Unlink, Normal text/Heading level, List, Table, Indent, Embed Image/Video/Audio/File, Embed External Media (e.g. YouTube); Reference (e. g, URL, or sources formally cited in CrossRef, Google Scholar, WordCat or other such online reference listings) with options to Render as a bracketed citation or a footnote in various referencing styles.

The Epistemic Helper toolbar 1102 supports the embedded Generative AI mechanism. On highlighting part or the whole of the drafted text, the Epistemic Helper toolbar offers Generative AI supported options including for instance: Brainstorm (gives the Creator ideas about whatever has been selected); Research (the web, shows summaries with links); Plan (suggests an outline); Expand (shows additions which the creator can accept or reject); Summarize (showing deletions which the creator can accept or reject); Translate (to a nominated language), Check Flow (analyzing the logic of argument or narrative flow, showing suggestions which the Creator can accept or reject); Advise (in response to a general query to the AI), and Proofread (show and explain suggested changes, which the Creator can accept or reject. Each of these functions is supported by embedded metaprompts, specifying in detail the processes the system is to undertake when each form of epistemic help is requested.

In process and functional terms, the KX Creator's interface (FIG. 11) is fundamentally a writing canvas with the special toolbars 1101, 1102, 1103 described earlier. The Structure toolbar 1101 and Epistemic AI toolbar 1102 behave as described, offering editing and AI functions respectively. The Semantic Web toolbar 1103 lets the creator invoke &tag suggestions or manually tag selected text with concepts from the CGML-federated ontologies.

As the creator writes, the system continuously applies an “origin flag” to each piece of text inserted. For example, if the user types a sentence manually, that text is labeled (in metadata) as human-origin. If the user clicks “Expand” and the AI generates a sentence that the user then inserts, that sentence (initially) carries an AI-origin flag. Conversely, if a user copies a large block from an outside source and pastes it in, the system flags it as “external” (neither the current human user nor the AI), tracks its source to the extent possible from the user's browser and clipboard, and prompts for a citation or verification. Most of these micro-level attributions are stored in the background, invisible to the creator during writing to avoid distraction, but available for later review. The contribution tracker monitors subsequent edits: if the user substantially alters an AI-suggested sentence, the system might flip that segment's flag to human (since the final text was mostly written by the human). For instance, the system might flip that segment's flag to human (since the final text was mostly written by the human), for example, based on calculating an edit distance exceeding a predetermined threshold, analyzing the percentage of modified text within the segment, or other computational linguistic metrics indicating significant human input.

The activity data captured is not just binary flags on text. The system records metrics, for instance:
Total number of AI suggestions taken vs. rejected.
Which functions of the AI toolbar were used for each action, and overall used most (brainstorm vs. proofread, etc.).
Time spent actively writing vs. idle vs. reading AI outputs.
Editing distance: how much the user modified each AI insertion (this can be a percentage to quantify how “pure” or heavily edited an AI contribution was).
Structural actions: e.g., how the document grew in sections and whether the user reorganized content (possibly indicating higher-order engagement).

In embodiments with advanced hardware, the system can incorporate additional Contextual AI signals: e.g., using the device camera for facial recognition to ensure the right person is writing (if required in a proctored exam scenario), or eye-tracking to see if the user is reading suggestions carefully. These are optional and would be used in high-stakes settings such as examinations requiring a written response.

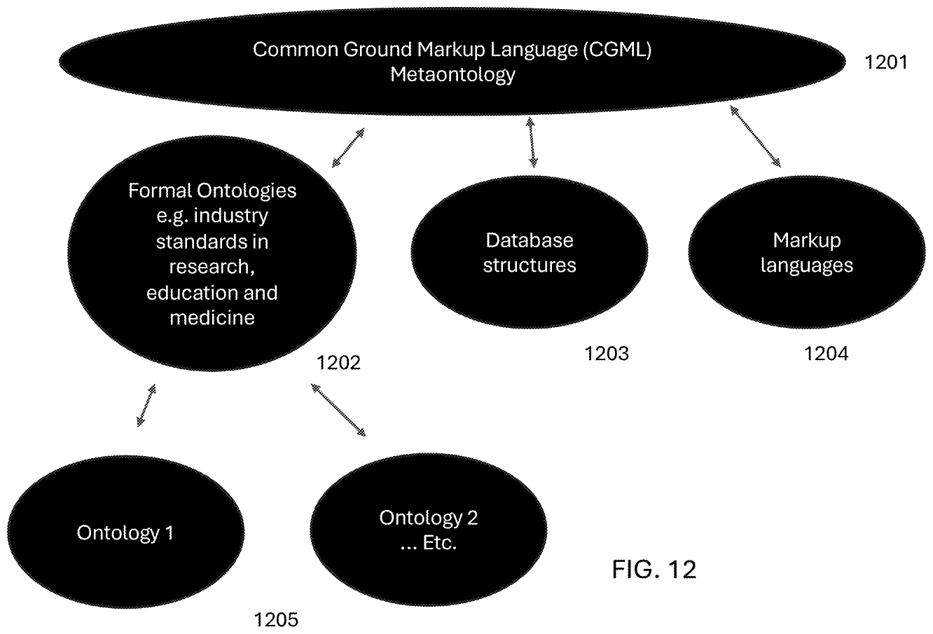

The Semantic Web Toolbar mechanism 1103 in the KX Creator subsystem supports the creator to markup their knowledge work with a high degree of semantic precision linked to instance-level databases and ontologies that manage the concepts by means of which these instances are classified. Multiple ontologies are federated by means CGML as illustrated in FIG. 12, a top-level metaontology consisting of Reference (instances, concepts, properties), Agency (actions, processes), semantic Structure (internal markers of information architecture and devices that create cohesion), Context markers (time, space), and Interest (sentiment markers) 1201. Ontologies federated over this overarching framework can include formal ontologies (e.g. industry standards in research, education and medicine) 1205 and informal ontologies as found in database structures 1203 or markup languages 1204. The system makes on-the-fly suggestions to creators using named entity recognition (NER) and relation extraction algorithms applied to the text, potentially constrained by the federated ontologies.

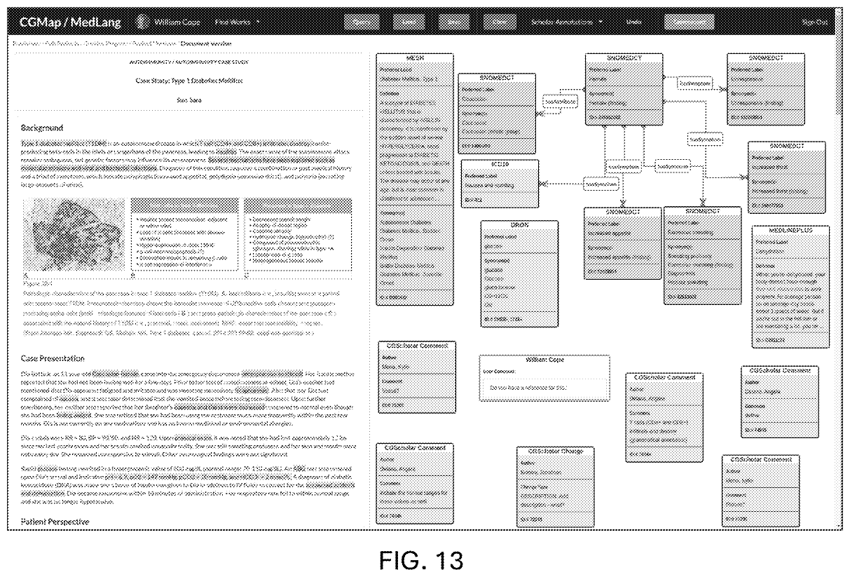

Creators and readers can also view works as knowledge graphs or concept maps, leveraging the underlying semantic web markup, optionally supplemented by freestyle topic models or concept maps. A sample illustration of one such knowledge graph is the screenshot provided in FIG. 13.

When authoring using the Semantic Web mechanism, a creator highlights a word which will then search the federated CGML metaontology and markup with a visible or invisible &tag. For instance, after typing the sentence “Phillip Kalantzis-Cope presented a paper at the International Conference on Learning in Granada in July 2024,” the Creator might mark up the name with an &tag which both captures the concept of formally registered author according to the ORCID database and his disambiguated instantiation as “0000-0001-6256-052X.” By highlighting the words “a paper,” the until now vaguely specified paper and its metadata might be more accurately specified elsewhere, for example by Digital Object Identifier in CrossRef's academic citation system and record its URL in Google Scholar. Similarly, the conference, date, and location might be specified with greater precision.

Modeled on the markup typically used for #tag folksonomies, the &tag mechanism adds supplementary depth of meaning to a work—hence the notion “and,” indicating the additional meaning. &tags can be added by highlighting a section of the work such as a word, phrase, section of text, image, video, embedded file, or the whole work.

Having highlighted the relevant words or phrases for potential addition of an &tag, the Creator can accept or reject the suggestion. Alternatively, the Creator can ask the system to create &tags for their whole text, so adding a layer of semantic precision not normally available in natural language. They can if they wish view and accept/reject &tags to validate and train the AI machine learning mechanisms driving the KX Creator subsystem.

Readers subsequently using a text marked up with &tags can leave these invisible, or show as links, or make them visible, for instance, Phillip Kalantzis-Cope (&ORCID 0000-0001-6256-052X).” The results of this training will improve the knowledge experience of later users by offering more accurate search as typically required in the various specialized knowledge domains for which this invention is intended, and refining the Knowledge Base through supervised machine learning mechanisms for subsequent RAG and CAG processes.

Knowledge administrators can add new ontologies, database structures, and markup languages to the CGML metaontology when expressed in industry standard formats such as XML and RDF. These will be federated into the metaontology using AI according to principles of most likely match through an interlanguage mechanism that connects concepts according to principles of ontology alignment and matching previously described in patent U.S. Pat. No. 7,886,225B2.

The &tagging process deserves an example to illustrate its impact. Suppose the user writes: “Dr. Alice Smith presented a paper on quantum computing at the conference in Paris in 2024.” If the user highlights “Alice Smith” and invokes &tag, the system might query an academic database or an internal list (via CGML links) and suggest: &Person(ORCID: 0000-0002-1234-5678) or some unique identifier for Alice Smith, if available, along with maybe &Role(Doctor) if “Dr.” prefix was recognized. Highlighting “paper on quantum computing” might allow tagging as &Work or linking to a DOI if known. “Paris” could be tagged as &Place(geonames ID or standardized coordinate), “2024” as &Time(Date). Each tag essentially pairs the text with a richer data object. The user can accept all, some, or none of these suggestions. The end document could have a hidden layer where each tagged phrase is annotated with these &tag objects.

This semantic layer can later be visualized: FIG. 13 shows a type of graph where “Alice Smith” is a node linked to a node “Quantum Computing Conference 2024—Paris” etc. It can also be used during AI review to ensure, for example, that if the AI says “she” in feedback, it knows who “she” refers to unambiguously (mitigating pronoun confusion or hallucinating details about Alice Smith that are not in the known data). The system achieves this by incorporating the linked ontological concepts from the &tags into the prompts sent to the Generative AI engine, or by using the tags to cross-validate generated output against the established semantic context.

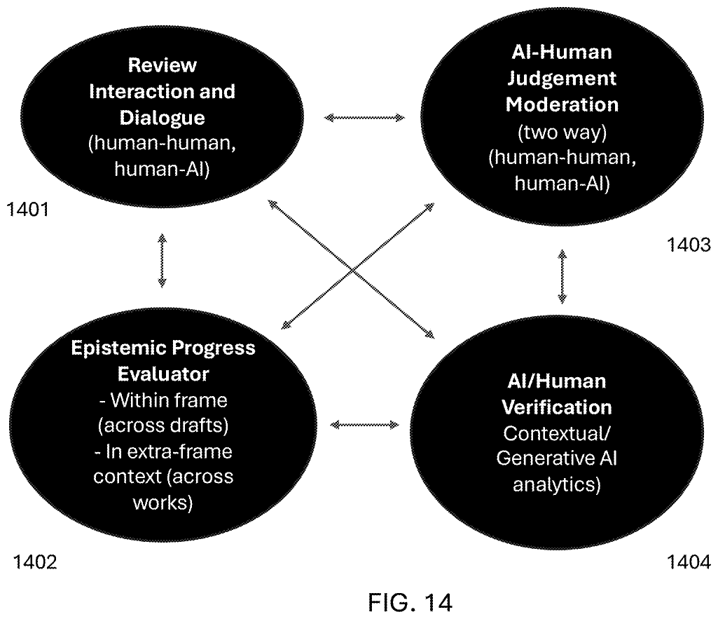

KX Validator Subsystem (FIGS. 14, 15-24) The third major subsystem in the overall KX system is the KX Validator subsystem. Thise can be operationalized after the completion of a draft work in the KX Creator, during drafting, or multiple times for successive drafts. FIG. 14 illustrates the components of this subsystem and their relationships. By means of interaction within the KX Validator subsystem, the creator interacts with human reviews (peer, self, administrator) and AI reviews 1401. This can be complemented with human-human, and human-AI moderation by means of which reviews are numerically rated and through the system and provided qualitative feedback 1403. At all times during the drafting process, incrementally updated verified data is available on the human-AI mix, measured in Ergons 1402. An Epistemic Progress Evaluator keeps a record of change and development within the project, and as well as across multiple projects over time 1404.

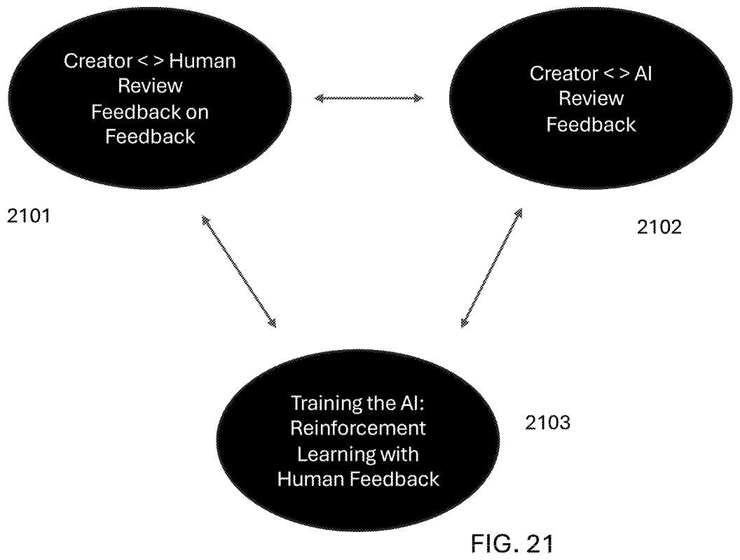

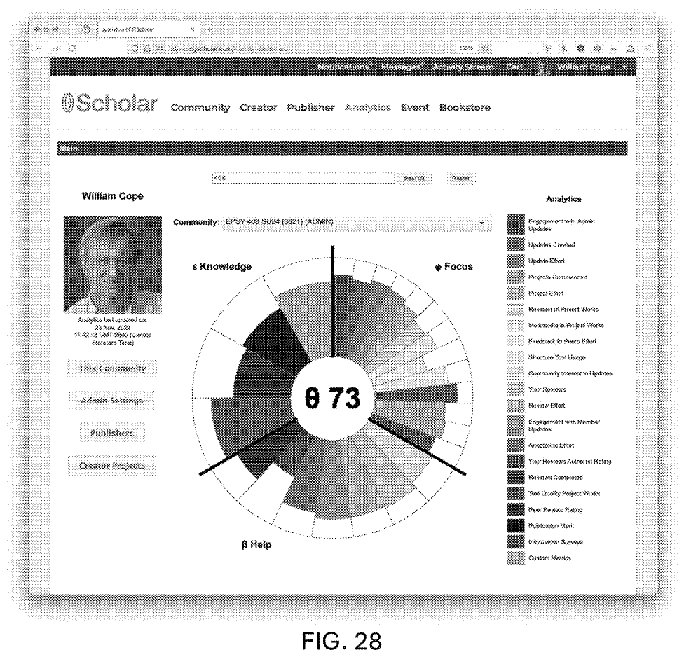

In process terms, once the creator finishes the draft and submits it for review (or if the system is set to auto-initiate review after a certain point), the KX Validator subsystem comes into play, as outlined in FIG. 14. We have already covered many aspects of this in the summary, but here we align with the figure references:
The creator's work can receive AI reviews and human reviews 1401. The system may allow multiple types of review concurrently. For example, an instructor's review and an AI review might both be generated for the same submission.
The system maintains an updated tally of human and AI contributions 1402 (Ergons) throughout. So at the moment of submission, it might say “Human A did X%, Human B did Y%, AI did Z%” and even break it down by category (e.g., “Idea generation: mostly AI, Writing: mostly human, Proofreading: AI made 10 suggestions, etc.”). This information is available to the evaluator and possibly to the creator as well.
Moderation interface 1403: This corresponds to FIG. 21 and related discussion: the platform where all feedback (AI and human) is gathered, and where creators can rate feedback quality. The system will highlight outliers (e.g., if one peer gave a much lower score than others or AI) and can adjust or flag those. For instance, if a peer review seems unfair, the instructor can see it at a glance and choose to omit it from the final grading, or conversely, if the AI missed a flaw that all human reviewers noted, that could inform refining the AI's rubric prompts.
Epistemic progress tracking 1404: Over the course of a single project, the system can show how the draft improved from initial submission to final version (like version diffs annotated with whether changes were prompted by AI or human feedback). Across projects, especially in LX, it builds a profile of growth. FIG. 28 exemplifies this with a chart or progress report.

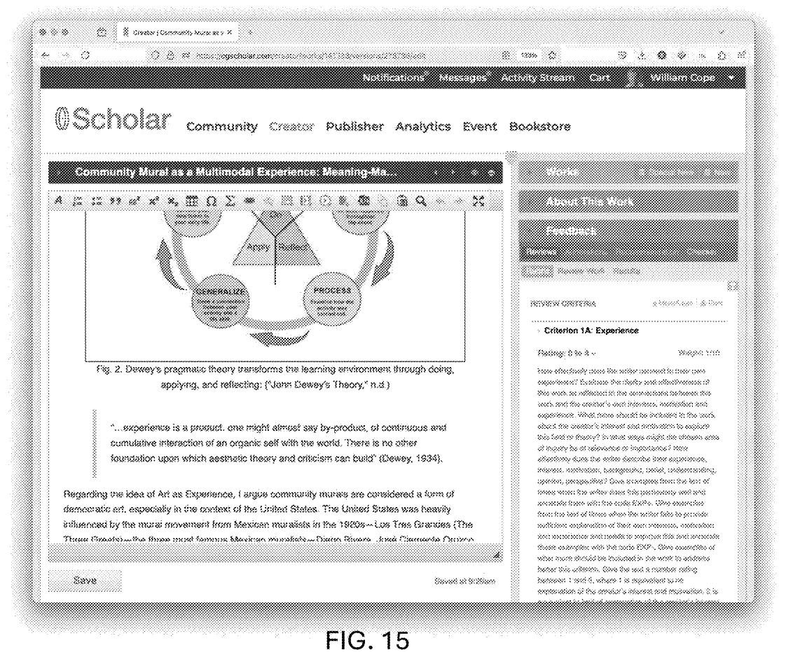

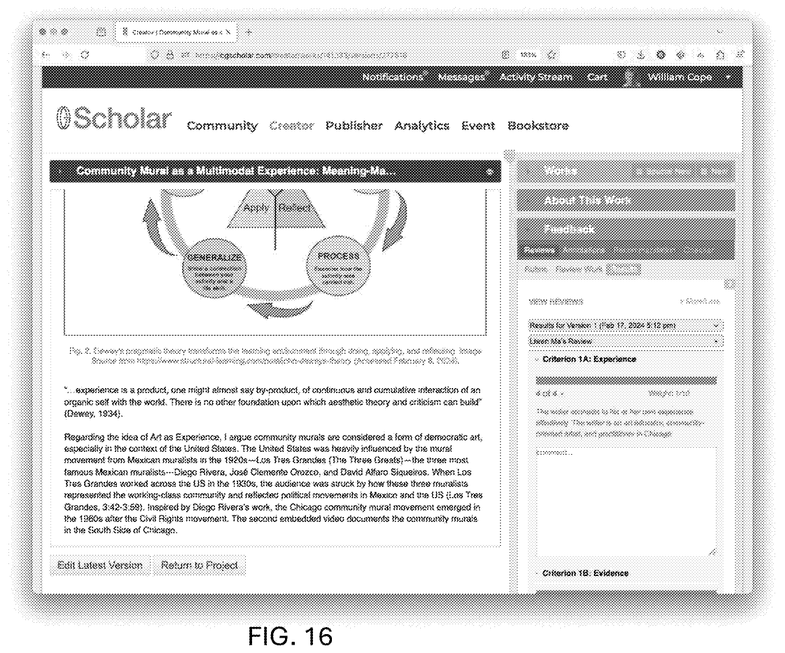

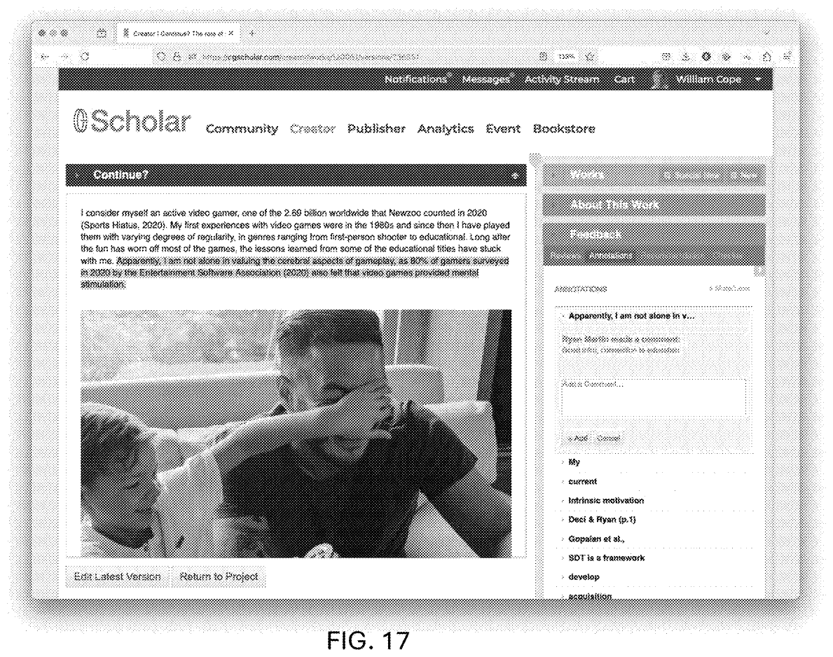

During drafting in KX Creator, as illustrated in FIG. 15, the evaluation Rubric for use by the AI and humans is visible on the right side of the screen. This is immediately available for self-review and AI review, and after submission for peer and/or admin review. Human feedback (peer, self, admin) based on the Rubric is illustrated in FIG. 16, including the capacity to respond to reviews, anonymously or as a named Creator, depending on Project settings. Human annotations are illustrated in FIG. 17, where according to the Project settings, annotators can be named or anonymous. Creators can respond to reviewers, anonymously or named according to the settings delimited by the administrator.

After human reviews are submitted, the KX Validator then supports the response phase: creators can reply to reviews or annotate their own document in response to feedback (sometimes called a “rebuttal” in academic peer review, or simply reflection in education). The system logs these interactions too, applying Ergons as appropriate.

Another feature in the Creator phase is the live rubric view (FIG. 15). The creator has access to the rubric criteria on the side of the screen while writing. They might occasionally click a button to self-evaluate or get an AI check on their current draft. This effectively triggers a mini Validator action during drafting: the AI will run through the criteria and give provisional feedback (“Your organization is strong, but evidence support is weak in section 2”). This helps the creator iterate without waiting for formal review. This is an optional guide—the creator is not forced to use it, but it is there as a constant reference of what the target expectations are.

In parallel, if human reviews are involved, peers or instructors will have their own dashboard to read the submission and fill in the rubric or add annotations (FIGS. 16 and 17 show these). The system may enforce that peers only see the work after they've submitted their own (to avoid copying, in a class scenario). They might also get AI assistance in writing their reviews (if enabled), but any AI help for writing a peer review is also flagged—so the instructor can later see “Peer X's feedback was 50% AI-suggested” if needed.

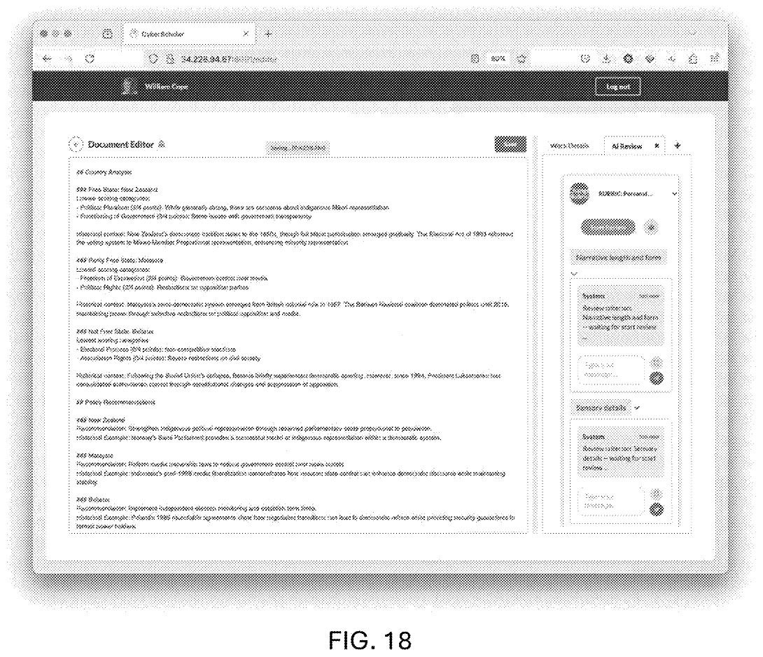

FIG. 18 illustrates AI Review, where the review criteria to be sent as prompts to the AI can be seen on the right side of the screen. On selecting the “Start Review” button, these are sent along with the full content of the work to Generative AI consisting of an API connection to the foundation LLM selected in the KX Administrator, fine-tuned by the RAG or CAG Knowledge Base. In a multi-pass analysis, the full content is analyzed one review criterion or Generative AI prompt at a time. For the purposes of AI review of multimodal works, embedded images, audio, and videos are automatically labeled by the system.

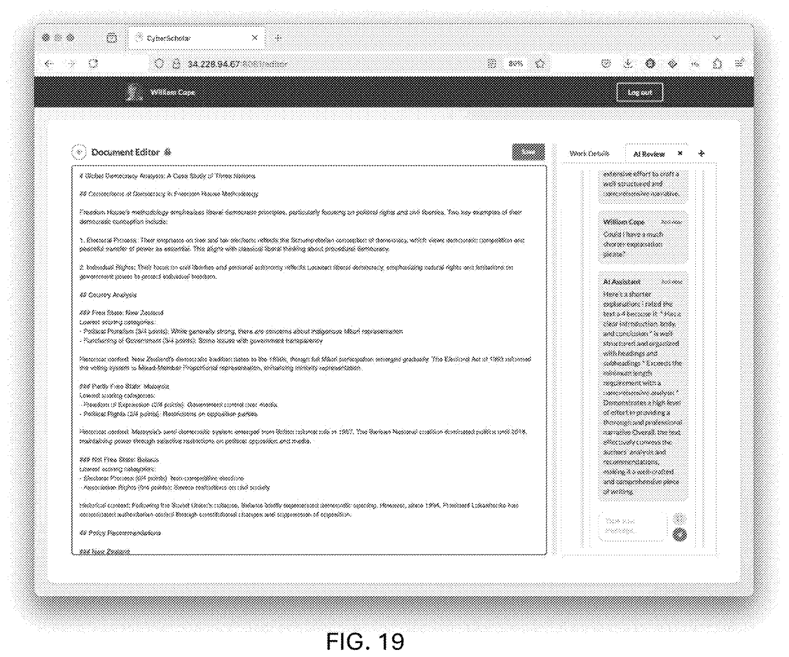

In FIG. 19, the AI review can be seen, addressing one criterion at a time. The Creator can create a message with which to query the AI review, such as “Would you explain this (specified aspect of your review)?” or “Would you say this in fewer words?” or “What would you suggest I should to improve my work (in a certain specified respect)?” The creator can also modulate the temperature of the AI to offer reviews which reflect congruent or lateral thinking.

In process terms, during the AI Review process (FIGS. 18 & 19), when the creator or admin clicks “Start AI Review,” the system packages the draft and sends it to the AI with each criterion prompt. FIG. 18's interface shows criteria on the side and would progress through them. The system automatically handles media in the text by labeling images/videos if needed (e.g., providing a text description from alt text or file name to the AI, since an LLM might not directly “see” an image). FIG. 19 then shows what an AI review might look like criterion by criterion. The creator can interact with this: for example, they might see the AI gave a certain comment and they want clarification, so they ask a follow-up question in a chat-like manner. This is allowed before they proceed to make revisions. The AI's “temperature” or style can be adjusted; a higher temperature might give more creative, varied feedback, a lower one more consistent, conservative feedback. If the AI's feedback seems off, the creator can flag it, which is recorded (and could earn them Ergons for helping train the AI).

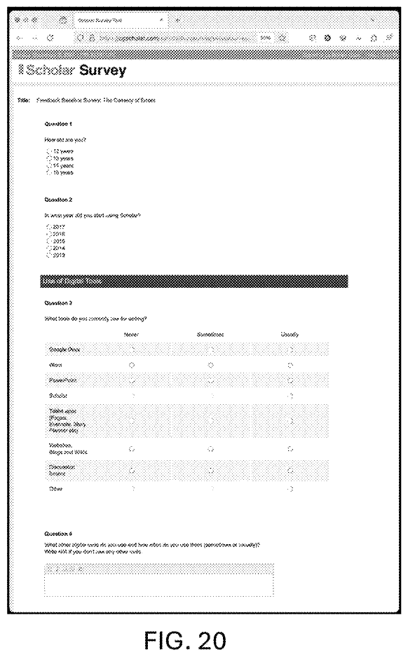

The administrator may wish to query the knowledge gains in the creation of a work using a select response or short answer survey, illustrated in FIG. 20. This can take the form of an Opinion Survey with no preferred answers, or a Knowledge Survey with preferred answers. In the KX Validator system the administrator may create a survey in a series of blank forms or ask the AI to create a survey and fill out administrator-editable forms based on the material provided in the overall Project plan, and/or the specific Objectives/Task Description, and/or Rubric, and/or Knowledge Base.

In process terms, FIG. 20's Knowledge Survey is a special feature that might be used in educational or training contexts. After finishing a project, an admin might push a short quiz to the creator to assess what they learned or to gather their opinions. The system can generate this quiz automatically using the context of the assignment (for example, if the assignment was about a certain topic, it can create a few questions on that topic to see if the student understands key concepts—that's a “Knowledge Survey with preferred answers”). Or it can be an opinion survey asking how the student felt about the process (no right or wrong answers). The results of such surveys can also be factored into the evaluation or just used for research/feedback on the system's efficacy. The AI can pre-fill answers or help analyze them if needed.

Human and AI feedback are moderated against each other in the KX Validator system according to the mechanisms shown in FIG. 21. Creators offer quantitative ratings and qualitative feedback on reviews 2101. This creates a measure of inter-rater reliability for the moderation of outlier ratings and reviews. Creators also rate and offer feedback on AI feedback 2102. Together, these human-in-the-loop evaluations are used to train future implementations of the Rubric and Knowledge Base by means of machine learning processes of Reinforcement Learning with Human Feedback (RLHF) 2103.

In process terms after the reviews are created, the creator is asked to rate the feedback they received. For each peer review, they might give a star rating on how helpful it was and optionally comment 2101. They do the same for the AI feedback 2102. This serves multiple purposes: it ensures creators engage with the feedback, and it generates data for RLHF (Reinforcement Learning with Human Feedback) 2103. Over time, the AI review system can learn which of its comments were consistently rated low by users and adjust to avoid those, and which were rated high to emulate those more. It also introduces an accountability for peer reviewers—if someone consistently gives low-value feedback (as rated by others), the instructor can see that and maybe adjust participation grades accordingly. In a professional setting, it could simply highlight which reviewers are contributing insightful reviews.

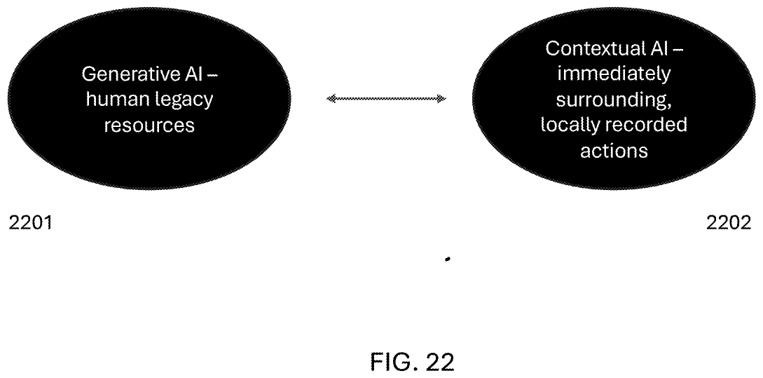

In order to determine the provenance of knowledge work, the KX Validator subsystem analyzes the relative contribution of the Creator and the AI per FIG. 22, based on instrumentation which captures in detail the mix of Generative AI 2021 and Contextual AI 2202. Generative AI supports are provided in the Epistemic Helper toolbar. Human activity is measured in Ergons on the basis of the highly granular instrumentation of keystroke, timestamp, clickstream, media upload, screen navigation, eye tracking, and other such mechanisms to capture the extent and nature of human knowledge work. In these ways, FIG. 22 focuses on provenance analysis: the system's combination of Generative AI logs 2201 and Contextual AI logs 2202 to determine who contributed what. The Contextual AI log includes the detailed keystroke and interaction data; the Generative AI log includes records of AI outputs given and whether they were used. By analyzing these, the system might generate a visualization or report. For example, it could overlay the final document text with color-coding: green for human-written, blue for AI-suggested, with gradients if mixed. It can also output a percentage or even a timeline in the form of a time lapse video replay of the document being written.

Any blocks of material pasted into the workspace will be by default assumed to be the work of another person or an AI external to the KX system and will require appropriate referencing or certification as to the provenance of that work. It will be advisable that the Creator undertake all their work in the KX Creator subsystem for the purposes of definitive verification of their human epistemic and knowledge-representational work. If, for instance, the creator copies their own work from another place, they will need to verify and certify that the source work was theirs, otherwise the default assumption will be that it is not their work. When permitted by the user and where possible, the KX system will track the provenance of copied and pasted work within the browser or the system clipboard, as well as clickstream data which traces sources reviewed in the process of creating the work. Security measures will apply here: if any text was pasted from outside, the system may attempt to check its origin (if it can access the clipboard or monitor copy operations). If it detects a large chunk that was copied from a web page, it might automatically fetch that page and attach it as a reference suggestion, or at least warn the creator to cite it. Also, the system can require the user to sign their work with a digital signature, or ensure the session is authenticated (facial recognition to ensure the right person is at the keyboard, etc.). These are configurable based on trust level of the environment.

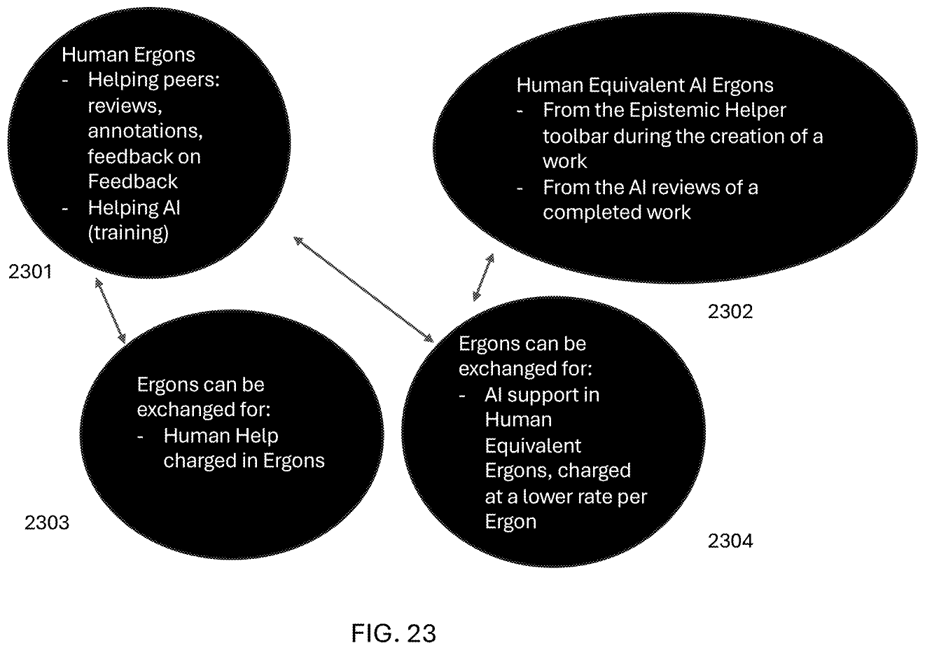

The Ergon measure is taken to be a proxy for intellectual effort, the mechanisms of which are shown in FIG. 23. The AI contribution is measured in Human Equivalent Ergons 2302—so, for instance, even though the AI might easily and quickly respond to a Creator request, the AI contribution will be measured as the amount of effort a human would need to exert for an equivalent response. The Validator will then measure comparative effort of human and AI effort as a percentage of overall effort.

When effort is for the benefit of a peer or to train the AI, Ergons will be credited to the human KX participants which can be exchanged with other KX participants when human help is needed. Human Ergons 2301 can be earned by writing reviews for others, annotating their works, offering feedback on feedback to other humans, and other such characteristic forms of collaboration in a knowledge community. They can also be earned for training the AI through RLHF 2304. Ergons can be exchanged with other humans when help is required 2303, for instance as for peer feedback. Human Ergons can also be traded for AI Ergons at a lower rate.

This, FIG. 23 covers the Ergon calculation mechanism. The “Human Equivalent Ergons” measures the AI's contribution in terms of how much human effort it replaces or represents. The Validator calculates:
Human Ergons 2301: points for the human's own work (this could be as simple as 1Ergon =1 meaningful edit or some composite metric of time, keystrokes, and complexity).
AI Ergons 2302: points for AI contributions, measured hypothetically.

It then compares them to give a ratio or percentage (e.g., Human did 50 Ergons, AI did 30 Ergons, so human ~62% vs AI 38% of effort).

Ergon crediting 2303: If the human did extra work that benefits others, like reviewing someone else's draft, those are counted as Ergons that the reviewer earns. The system can thus show, for example, that a student reviewed 3 peers and earned 15 Ergons which they can use later.
Training contributions 2304: If the user participated in training the AI (like by writing a lot of feedback on AI suggestions, or consistently rating AI feedback, or by curating the knowledge base which improves AI responses), those actions are logged as contributions to the AI's knowledge. The system might reward that with Ergons too, recognizing the user's role in making the AI better for everyone. When the KX Creator workspace is used for the creation of multiply authored works, the relative contributions of each creator are measured in Ergons and evaluated separately. In this way, in a multi-creator scenario (co-authored documents), the system can separately tally Ergons per person. So, if two students wrote an essay together in KX Creator, it might conclude student A contributed 60 Ergons and student B 40 Ergons—useful for individual grading or credit.

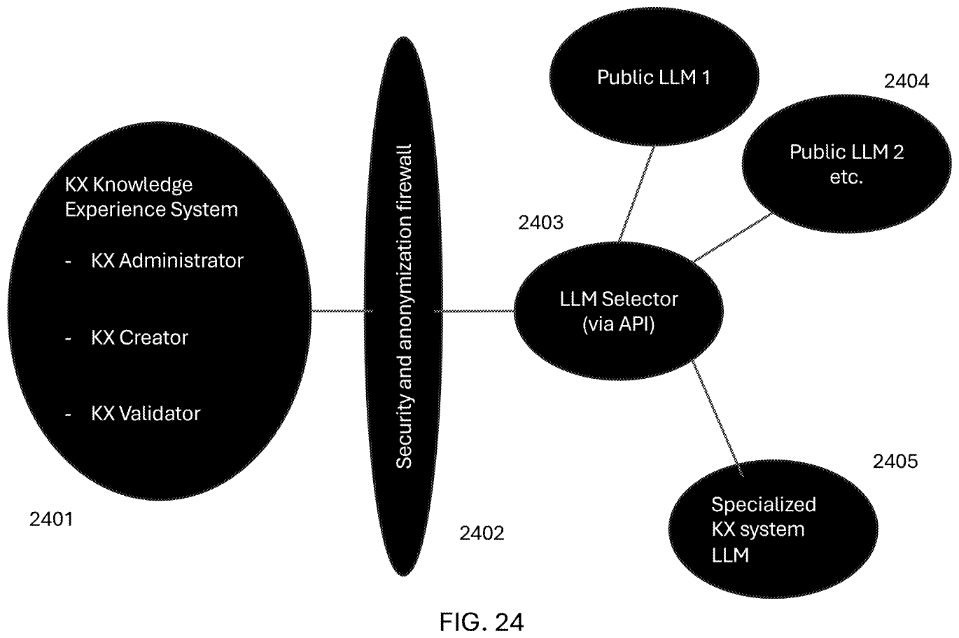

Per FIG. 24, the three KX Knowledge Experience subsystems, KX Administrator, KX Creator, and KX Validator 2401, are separated by secure anonymization 2402 from any foundation LLM 2404 to which the KC system may happen to be connected via API. Alternatively, the system may use its own, dedicated LLM 2405.

Therefore in process terms, FIG. 24 deals with privacy/security. When generative AI functions are called (for example, to get a suggestion or an AI review), the system can utilize a foundation language model (LLM) via API. The design allows flexibility: the LLM could be a third-party service or a dedicated model provided with the system. In cases where data security is paramount, the KX system might use an on-premises LLM. (FIG. 24 shows both possibilities: an external foundation LLM 2404 or a dedicated LLM 2405 behind a firewall 2402.). This ensures that confidential content (academic drafts, student essays, patient records, etc.) never leaves the secure environment unless appropriately anonymized. In this way, the deployment of KX can be such that all interactions with any foundation AI model go through a secure anonymization layer 2402. This means if the KX system calls OpenAI's API, for instance, it would strip out or tokenize any sensitive info (names, etc.) or work within an encrypted channel, or even route through an in-house proxy that ensures data isn't logged externally. In extremely sensitive cases, an organization can plug in their own LLM 2405 into the KX system, so no external call is needed at all. The system is designed to be model-agnostic: today's GPT-4 could be used, but tomorrow if a new model or a fine-tuned local model is preferred, the KX can integrate with that. The key point is the user's content and identity remain protected as per the requirements of research confidentiality, student privacy (FERPA laws), patient privacy (HIPAA), etc.

RX (Researcher Experience) Embodiment: In the RX Researcher Experience embodiment (one specialized configuration of the KX system for scholarly work), the emphasis is on supporting academic writing and publishing workflows. A research administrator (like a journal editor or a research supervisor) using an RX Administrator can configure projects such as journal article submissions or grant proposals. They will likely include robust knowledge bases (e.g., the entire archive of relevant literature, citation libraries) and rubrics that reflect research quality criteria (originality, rigor, literature review quality, methodology soundness, etc.). The Knowledge Base for RX might be populated with the institute's publications or relevant datasets. The generative AI in RX can help authors by suggesting literature to cite (via the Research function), summarizing related work, or even formatting references. The metaprompts in the epistemic toolbar might be tuned to academic writing: for example, an AI suggestion might be to strengthen a hypothesis statement or check for proper reporting of results.

During validation in RX, there is often a peer review stage. The KX Validator in RX can facilitate double-blind peer review. Reviewers (who are likely other researchers) can use the system to write their reviews, possibly with AI assistance to ensure they consider all rubric points. The provenance tracking in RX assures editors that a submitted paper's content is the authors'own (with AI usage disclosed by the system). If a researcher uses the KX Creator to write a paper, they can submit along with it a provenance report showing exactly how and how much AI was used—something journals are starting to ask for. This embodiment thereby systematizes concurrent human and AI roles in research: the human authors, the human peer reviewers, and the AI (as writing assistant and as an evaluator) all contribute in a coordinated workflow for producing publishable research.

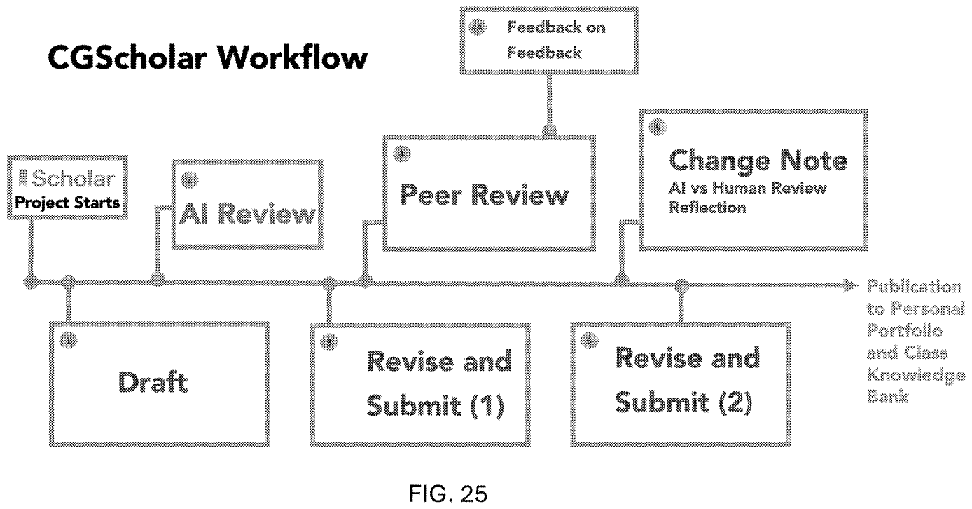

LX (Learner Experience) Embodiment: After being assigned a knowledge creation project, students will write their assignments in the LX Creator workspace. A typical project workflow for a student assignment in the LX system is illustrated in FIG. 25. In the LX Learning Experience embodiment, the KX system is configured for educational settings (class assignments, tutoring systems, etc.). Here, the knowledge administrator is typically a teacher or instructional designer. In the LX Administrator subsystem, the teacher sets up an assignment with learning objectives, attaches class materials to the knowledge base (textbook excerpts, lecture slides), and possibly links the rubric to standards (like Common Core or Next Generation Science Standard in the US). The system might integrate with an LMS via IMS/LTI (Learning Tools Integration), so students access KX Creator through their class portal with single sign-on.

One feature in LX is that the teacher can decide if the Epistemic Helper toolbar is visible to students or not. For example, an instructor might initially hide AI assistance for a first draft to encourage original student effort, but allow AI suggestions in the revision phase. They can also set a target mix (e.g., “at least 70% of the writing should be student's own”) and the system will report if the student falls short, prompting them to contribute more themselves.

The adaptive Knowledge Survey is particularly useful in LX. After an assignment, the system can quiz the student and adapt the difficulty based on previous answers, for the purposes of both formative and summative assessment. Also, because the system profiles the student's ZPK, over time it will adjust AI feedback complexity—essentially the AI will always try to operate in the student's Zone of Proximal Development, offering hints and guidance that are just challenging enough to aid learning without doing the work for them.

A typical LX workflow (FIG. 25) might be:
Teacher assigns project via KX (possibly created with AI assistance).
Student writes in KX Creator. The rubric is visible (maybe they self-check with AI).
Student submits; KX Validator gives an immediate AI review (if allowed).
Peers are automatically assigned, do reviews (with or without AI help as permitted).
Student gets peer reviews, perhaps an AI summary of the peer feedback as well.
Student writes responses to reviews and revises the draft.
Teacher (admin) reviews final draft and all the process data (who used AI how much, etc.), and gives a grade.

All this data can sync back to the LMS gradebook via the IMS/LTI API. Alternatively, the student can upload the work with provenance report to the teacher into the LMS, or a provide a link there.

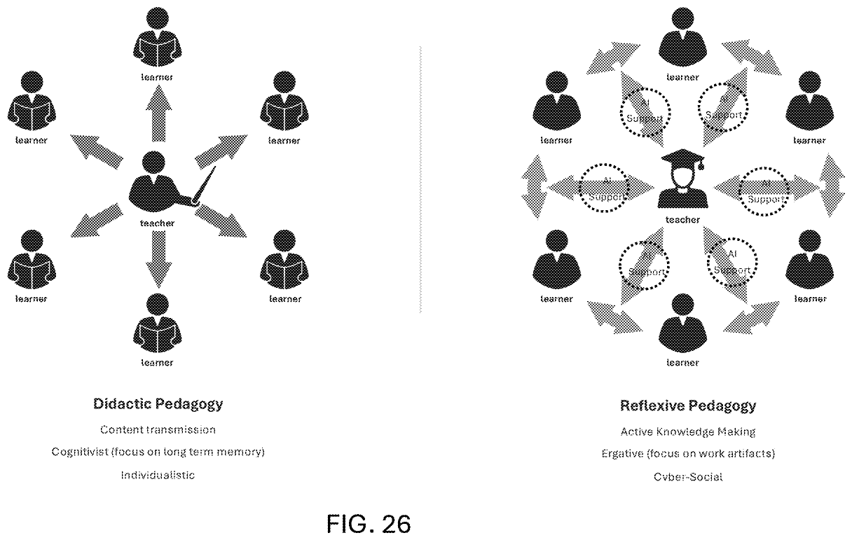

As illustrated in FIG. 26, the development of the LX system represents a paradigm shift in education, from knowledge transmission models of teaching and learning typical of existing LMSs, to collaborative learning where one of the collaborators is the AI. This paradigm shift emphasizes that instead of a student writing something alone and teacher only seeing the final product (legacy model), now the student, peers, and AI are in a loop: the AI is like an ever-present teaching assistant guiding the student, and the teacher's role shifts more to monitoring the process and intervening when needed. It is a more collaborative and transparent learning process.

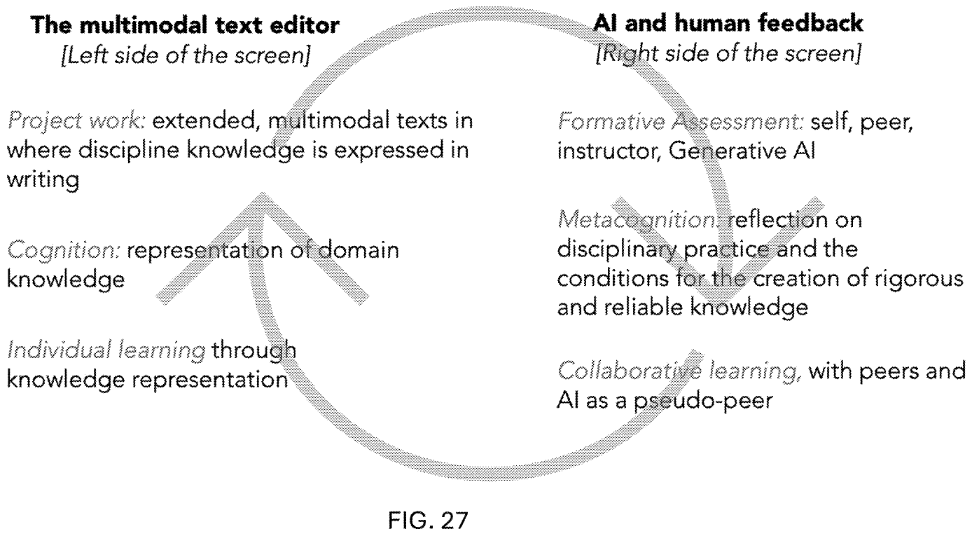

One of the bases of the paradigm shift in this invention is the left < > right screen architecture of the KX Creator screen as illustrated in FIG. 27. By this system, the linear knowledge processes (acquire knowledge>test long term memory of that knowledge) typical of legacy LMS architectures is transformed into dialogical or dialectical knowledge development workspace leveraging both collaborative human feedback and synergistic AI feedback.

The LX Validator generates both formative and summative assessment data which can be exported to the gradebook of any LTI-compliant LMS. Alternatively, students will be able to do their work on the Creator subsystem, then export a PDF for submission to their teacher or send a link to their teacher with verification data of the extent and nature of AI support in the writing process.

FIG. 27's split-screen is implemented in our prototype LX interface: the left side is the student's essay draft, the right side can toggle between rubric, AI chat, peer comments, etc. This trains students to continuously engage in reflection and revision rather than only at the end.

During the formative assessment phase, adapting the psychologist Lev Vygotsky's notion of Zone of Proximal Development (ZPD), the feedback provided by the AI is tuned via a series of metaprompts to the Zone of Proximal Knowledge (ZPK) as evidenced in the work. Over a period of time and extended uses of the LX system, the system will develop an individual learner profile in order to calibrate feedback so remains in the range of the ZPK that is most productive for learning—at the lower threshold of the zone, sufficient to challenge the learner beyond their current level of knowledge and understanding, yet always within an upper threshold of intelligibility in terms of their current level of knowledge and learning.

The ZPK personalization is an advanced feature: the system uses past data (like how the student responded to AI feedback before, what their knowledge survey results are, etc.) to tune future feedback. If a student is very advanced, the AI might give more subtle, challenging critiques; if a student is struggling, the AI will focus on fundamental issues and be more tutorial in its feedback. Over time, each student (or creator) gets a profile that the system uses to maintain the right level of assistance. Maintaining the ZPK profile may involve analyzing metrics derived from past interactions logged by the contribution tracking module, such as the creator's acceptance/rejection patterns for specific types of AI suggestions, performance on integrated knowledge surveys (as described in FIG. 20), the semantic complexity of the creator's own writing, or explicit feedback provided on AI assistance usefulness. The system then adapts AI suggestions, for instance, by automatically adjusting parameters in the underlying prompts sent to the Generative AI engine to request simpler vocabulary, more foundational explanations, or conversely, more nuanced critiques or challenging counterarguments, thereby optimizing the assistance for the creator's current knowledge level.

The LX validator will provide summative assessment results, both as progress assessments for an individual learner and comparative assessments with equivalent peers. A screenshot of an individual progress assessment visualization is provided in FIG. 28. All such results and learner ZPK profiles will be maintained securely in the system according to strict privacy profiles, accessible only to learners and their trusted teachers, education administrators, or guardians.

In these ways, the LX Validator outputs can differentiate between formative assessment (feedback to improve) and summative assessment (the final evaluation). The summative results can show how much the student improved, how much help they got, and compare to peers. Privacy is maintained so that only authorized people (student, teacher, maybe parent) can see an individual's detailed profile.

This LX embodiment demonstrates the system's flexibility in an educational workflow, aligning with claim 4 which is specific to student assignments.

HX (Health Experience) Embodiment: The HX Health Experience embodiment adapts the KX system to medical documentation, specifically an Electronic Health Record (EHR) scenario. Here, the “creator” is a medical professional (doctor or nurse) writing patient notes, and the “administrator” could be a healthcare IT admin or chief physician setting up the system's parameters (or the system might come pre-loaded with medical knowledge bases and rubrics). The rubrics in HX could be based on standard structures like “SOAP” notes (Subjective, Objective, Assessment, Plan). The system can have a rubric for each of these sections or aspects of a patient encounter note.

The Knowledge Base in HX would include medical reference materials: drug databases, ICD (International Classification of Diseases) codes, clinical guidelines, etc., with integration into EHR systems via HL7 standards for seamless patient data import and an AI-powered terminology checker ensuring alignment with standardized vocabularies (e.g., SNOMED CT, ICD-10). The &tag system here shines by linking clinical terms to formal ontologies (BioPortal, ICD, Drug Ontology, etc.). For example, if the doctor types a diagnosis, the system can &tag it with the corresponding ICD-10 code automatically. Or if they mention a medication, it tags it with a standardized drug identifier. This not only helps the AI in giving context-aware suggestions (e.g., ensuring the AI doesn't hallucinate drug names or suggest wrong dosages) but also streamlines documentation for billing/coding and decision support.

Contextual AI in HX can include things like voice transcription of doctor-patient conversations, analysis of medical images or vitals attached to the record, etc., as part of the input context for generating notes. For example, the doctor could record the patient visit and the AI might generate a draft SOAP note from that transcript, which the doctor then edits in KX Creator (with everything tracked). The AI could also generate two versions of notes as described: one technical (for the medical record) and one in layperson terms (for the patient to read on their portal), ensuring consistency between them but tailoring language appropriately. The doctor's role becomes editing and confirming the AI's suggestions, and the system tracks those edits to make sure the final note is approved by the human (for liability).

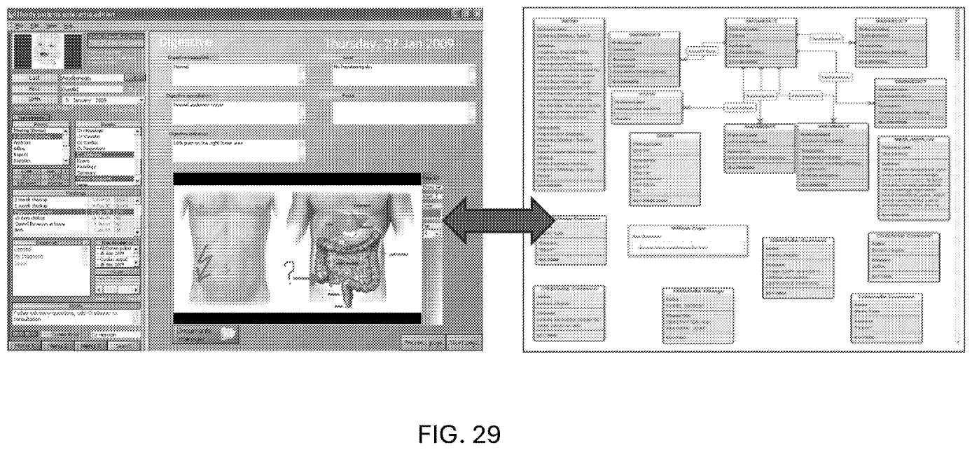

FIG. 29's health condition graph would be created by all those &tags. Imagine a patient's record tagged with symptoms, diagnoses, lab results—the system can generate a knowledge graph linking this case to related cases or medical knowledge. This can help in decision support (like reminding the doctor of a guideline or alerting if something is inconsistent).

Provenance tracking in HX is crucial because it could provide accountability: if later audited, the hospital can show exactly what was written by the doctor vs suggested by the AI. If an error is found, they can trace whether it was an AI suggestion that the doctor overlooked or a human entry, which is important for refining procedures and responsibilities.

The system will also generate health condition knowledge graphs based, federating multiple medical ontologies according to CGML mechanisms for the purposes of precise documentation for insurance and decision support.

Security and privacy are extremely important in HX, so this embodiment uses the strictest privacy setting (the anonymization layer to any external AI, or a local model). It might also integrate with existing hospital login systems and audit logs.

In summary, the HX embodiment showcases how the system can maintain the human-centric nature of critical work (medical decisions) while leveraging AI to improve efficiency and thoroughness in documentation. It aligns with claim 5, focusing on creating patient notes with concurrent AI support and ensuring provenance of the medical professional's input.

1. An AI-assisted writing system, comprising:
a user interface module configured to receive text and multimodal inputs, including images,
video, and audio, from a human creator and to present an editing workspace with real-time feedback and progress analysis;
a Generative AI engine operable to produce context-relevant writing suggestions and automated reviews in response to the content in the workspace and a domain-specific knowledge base;
a contribution tracking module (Contextual AI) configured to log, in real time, each segment of content in the workspace with metadata indicating its source or origin (human-entered, AI-suggested, or externally sourced), and to dynamically update said metadata when the human creator modifies AI-suggested content, using contextual activity data including keystrokes, mouse actions, edits, time spent, and the frequency and nature of AI tool usage; and
a display module configured to render the document to the human creator and, upon request, visually indicate the origin of each portion of content using color-coding or annotations to distinguish between human-written, AI-generated, and externally sourced text.

2. The system of claim 1, wherein the contribution tracking module is further configured to:
assign unique identifiers to each human and AI contribution event, enabling precise auditing and reconstruction of the document's development history and the kinds of human and AI contribution in each instance;
export contribution data in a standardized format (e.g., JSON, CSV) for integration with external analytics tools.

3. The system of claim 1, wherein the display module is further configured to:
render a timeline slider that allows users to scrub through the document's evolution, highlighting changes made by humans and AI at each point; and
provide an accessibility mode with high-contrast visuals and screen-reader compatibility for contribution reports.

4. A method of supporting human knowledge creation with AI assistance while distinguishing contributions, the method comprising the steps of:
defining a set of user roles in a knowledge experience system, including an administrator to configure the system, a creator to develop content, and a reviewer to evaluate the work;
providing a KX Administrator subsystem for the administrator role to establish a knowledge frame for a project, including setting task objectives, configuring AI assistance parameters, creating or selecting an evaluation rubric with weighted criteria, and supplying a domain-specific knowledge base processed for retrieval-augmented generation or cache-augmented generation;
providing a KX Creator subsystem for the creator role, wherein the creator composes content with on-demand AI assistance, and the system logs all actions and contributions in a real-time activity record;
providing a KX Validator subsystem for the reviewer/evaluator role, to evaluate the completed content using the rubric, generating quantitative scores and qualitative feedback from AI and human reviewers, and producing a contribution report detailing human versus AI inputs; and
offering the option to dynamically maintain a Zone of Proximal Knowledge (ZPK) profile for the creator by analyzing past interactions and performance via machine learning, adapting AI suggestions to the creator's knowledge level to optimize learning and productivity.

5. The method of claim 4, wherein the system is configured as an RX (Researcher Experience) embodiment to support scholarly writing and publishing, such that:
the KX Administrator subsystem enables definition of research-oriented objectives, rubric assessing originality and methodology, a knowledge base with previous publications and other resources related to the specific domain, and the inclusion of scholarly references in the knowledge base, including integration with academic databases (e.g., PubMed, CrossRef) for citation management;
the KX Creator subsystem provides writing assistance focused on academic writing attributes (including for instance theoretical framing, literature review, data analysis, literature synthesis, citation formatting, and hypothesis development), logging all interactions to verify authorship; and
the KX Validator subsystem facilitates a peer review workflow, including AI-generated referee reports and human peer reviews, to systematically evaluate the quality and originality of a research manuscript before publication.

6. The method of claim 4, wherein the system is configured as an LX (Learner Experience) embodiment to support educational assignments, such that:
the KX Administrator subsystem allows an instructor to set learning objectives, attach curriculum materials and standards to the knowledge base, and define an assessment rubric;
the KX Creator subsystem functions as a student writing workspace with an optional AI tutor, wherein the availability or extent of AI assistance as an AI tutor is adjustable by the instructor (including being disabled for certain phases) and the system monitors the student's contribution relative to AI help via real-time tracking; and
the KX Validator subsystem conducts AI-assisted grading and human peer review of the student's work, provides formative feedback aligned with the rubric, tracks the student's progress over iterations, and reports the verified mix of student effort vs. AI assistance for transparency in evaluation, integrating with learning management systems via standards like LTI.

7. The method of claim 4, wherein the system is configured as an HX (Health Experience) embodiment to support medical documentation, such that:
the KX Creator subsystem is integrated into an electronic health record interface for a medical professional to write patient notes (including for instance subjective, objective, assessment, and plan sections) with AI suggestions for medical terminology, diagnoses, or treatment plan drafts, suggesting for diagnoses and treatments based on medical ontologies (e.g., SNOMED CT, ICD-10) and a knowledge base of professional medical and research literature as identified by the administrator;
the contribution tracking module logs AI-proposed content in the draft so that the medical professional's edits and confirmations are recorded for each suggestion, ensuring the final for the purposes of accountability that the patient note's provenance is clear;
the KX Validator subsystem evaluates the completed note for completeness and clarity using a medical rubric and compiles a secure report on the human-AI collaboration (including any medical ontology &tags used, and verification that the professional reviewed all AI contributions), thereby supporting accountable and transparent clinical documentation as well as generating technical professional-facing and patient-facing versions; and
integration is effected with electronic health record (EHR) systems via HL7 standards, enabling seamless integration and corroboration of patient data and patient notes.

8. The method of claim 4, wherein the system is applied to any other collaborative knowledge domain, such as legal drafting, (an “?X” embodiment) requiring quality evaluation and provenance validation, by systematizing concurrent human and AI roles and functions in the creation of a shared work-product.

9. The system of claim 1, further comprising a real-time contribution ledger module configured to analyze data from the contribution tracking module to compute a running measure of the relative contributions of the human creator and the AI engine during content development, wherein the ledger quantifies human effort (differentiated according to multiple creators and reviewers where applicable) versus AI-generated content by analyzing contextual activity data (including keystrokes, edits, time spent, and frequency of AI tool usage) in relation to generative outputs, using this ledger to produce a contribution ratio or report upon completion of the work, thereby enabling verification of authorship proportions between creators, reviewers, and detection of the extent of their reliance on AI.

10. The system of claim 9, wherein the contribution ledger module is further configured to generate a contribution summary certificate, digitally signed with a timestamp, for use in intellectual property disputes or authorship verification.

11. The system of claim 1, further comprising an evaluation module configured to generate both quantitative scores and qualitative feedback on a created work using a predefined rubric, wherein:
the evaluation module interfaces with the Generative AI engine to produce an AI-generated review for each rubric criterion, and
additionally enables one or more human reviewers to input ratings and feedback on the same criteria, and then
automatically compares and moderates the AI-generated feedback against the human-provided feedback to moderate AI and human feedback using statistical methods to identify discrepancies, generating a composite evaluation report.

12. The system of claim 1, wherein the contribution tracking module is further configured to support collaborative multi-author and multi-reviewer scenarios by distinguishing and logging inputs from multiple human creators and reviewers alongside AI inputs, wherein the system provides a mechanism to calculate and display the relative contribution of each human co-creator to a shared work, including the attributing portions of the document to specific users and quantifying each person's effort (for example, in Ergon units or percentage of total contributions) when multiple creators are editing the document in the KX Creator workspace, and when non-author reviewers are providing advice and offering suggestions.

13. The system of claim 9, wherein the contribution ledger further incorporates an Ergon credit mechanism that calculates and awards Ergon units for contributions that go beyond the creator's own writing of the work, including:
peer review contributions, such as reviewing or annotating others'works, or providing feedback on AI outputs (thereby assisting in AI model improvement), and
human-in-the-loop AI training actions, such as the creator correcting or fine-tuning AI suggestions (reinforcement feedback), such that the system tracks these collaborative and training efforts and credits them to the respective users in the form of Ergon units; wherein these Ergon units are stored in a user's account and are exchangeable within the system, allowing users to redeem them for receiving help on future projects or other benefits, thereby incentivizing active collaboration and oversight;
a tiered reward system where higher-quality contributions (e.g., original research, complex edits) earn bonus Ergons; and
a decay function that reduces the value of unused Ergons over time, encouraging active participation.

14. The system of claim 1, further comprising a semantic tagging module (the “&tag” system) configured to allow the human creator (and/or the AI engine) to tag portions of the content with semantic labels linking them to entries in a meta-ontology and one or more domain-specific ontologies; wherein the semantic tagging module adds a layer of machine-readable metadata to the content &tags content with semantic labels linked to a meta-ontology (CGML) and domain-specific ontologies and in so doing:
disambiguates references in the content by linking terms to unique identifiers or definitions (thereby reducing ambiguity in AI processing);
reduces AI hallucinations by grounding generative AI suggestions in the semantically enriched context (the AI can cross-check tags for consistency); and
enables more accurate search and retrieval of content by leveraging the tagged semantic information, including generation of knowledge graphs or concept maps from the content;
links &tags to external knowledge graphs (e.g., BioPortal, Schema. org, DBpedia, Wikidata) for enriched contextual understanding.

15. The system of claim 14, wherein the Generative AI engine utilizes the semantic labels applied by the semantic tagging module to reduce ambiguity or hallucinations in the context-relevant writing suggestions and automated reviews it produces.

16. The system of claim 1, wherein the system is deployed in a secure computing environment for sensitive knowledge creation contexts (including research with confidential data, educational settings, or healthcare records), and the system includes a security module that maintains privacy by ensuring any communication with external AI services is fully anonymized or pseudonymized; wherein the security module mediates interactions with foundation LLMs such that no personally identifiable or sensitive information is exposed, or alternatively, the system utilizes a locally hosted AI model to process the data, thereby maintaining a private and secure environment for human-AI collaboration in compliance with institutional or legal requirements; to the effect that the system:
anonymizes or pseudonymizes data sent to external AI services via encryption and secure
APIs;
provides multi-factor authentication (MFA) for all user logins, with options for biometric or hardware token verification;
includes a data anonymization feature that strips personally identifiable information from contribution logs for research purposes;
optionally uses a locally hosted AI model to prevent data exposure; and
complies with standards and laws such as GDPR, HIPAA, or FERPA for sensitive environments.
